(19) United States
(12) Patent Application Publication
(10) Pub. No.: US 2009/0014691 A1
(43) Pub. Date: Jan. 15, 2009

(54) Dispersions, films, coatings and compositions

(75) Inventors: Darwin P.R. Kint, Abbots Langley (GB); Fouad Salhi, Bridgewater, NJ (US); Gordon John Seeley, Saltburn-by- the Sea (GB); Andrew Nigel Burgess, N. Yorks (GB)

Correspondence Address: JONES DAY, 222 EAST 41ST ST, NEW YORK, NY, 10017, US

(73) Assignee: Imperial Chemical Industries PLC., London (GB)

(21) Appl. No.: 11/664,350

(22) PCT Filed: Sep. 23, 2005
(86) PCT No.: PCT/GB2005/003670

§ 371 Date: Aug. 5, 2008

(30) Foreign Application Priority Data
Oct. 1, 2004 (GB) 0421782.4
Aug. 10, 2005 (GB) 0516415.7

(51) Int. Cl. H01B 1/12; C08K 9/04; C08L 23/00; C08L 61/02; C08L 63/00

(52) U.S. Cl. 252/500; 523/216; 523/200; 523/202; 523/208; 523/209; 252/182.12; 252/182.3; 977/742

(57) ABSTRACT

A method of providing location dependent content to an end station using a base station. The base station receives from an end station and via a communications network, a content request, and an identifier indicative of an identity of the end station. The base station then authenticates the user or the end station using the identifier. In response to a successful authentication, the base station determines the location of the end station and determines content using the location or the content request, which is then transferred to the end station.

This invention relates to dispersions, films, coatings and composites. In particular, the invention relates to dispersions of fine particles and to films, coatings and composites containing fine particles. More especially, the invention relates to dispersions of fine conducting particles and to films, coatings and composites containing fine conducting particles.

In this specification, the term “fine particles” means particles of micron and sub-micron size and more especially nano-scale particle sizes. In particular, the term “fine particles” means particles having a size of not more than 100 μm, preferably not more than 10 μm and especially not more than about 1 μm. Such particles may be regular or irregular in shape and includes particles having significant aspect ratios such as flakes, platelet, fibrous and tubular type particles.

There are many applications that require dispersions of fine particles to be made and for films or coatings containing such particles to be made using dispersions. Such applications include pigments for paint and ink formulations; conductive paint formulations; conductive particles for forming thermally or conductive coatings or films or for incorporation in composites; battery coatings; particles for imparting toughening or other property-enhancing affects, eg flame retardancy, in films or composites; etc.

The use of thermally and/or electrically conducting fine particles is of particular interest and such particles are used in many applications, for example in electrostatic dissipation (ESD) coatings, electromagnetic and/or radio frequency interference shielding (EMI/RFI), flat panel displays, electron emission displays, touch screen applications, conductive inks, and in molecular electronics and nanotechnology applications. There are a wide variety of conductive fine particles such as metal and metal oxide particles, eg gold, silver, indium tin oxide; carbon particles, eg carbon black, graphite, carbon nanotubes, carbon nanowhiskers and fullerenes, conductive polymers, such as polyaniline, etc that are useful in such applications. Other applications include the use of non-conductive particles, such as silica, (whether alone or in combination with conductive particles) for controlling thermo-mechanical properties of composite materials.

Many such fine particles are made into aqueous or organic solvent based dispersions for making coatings and films and for inclusion in composite materials. However, many such dispersions suffer from settling of the particles before use of the dispersions leading to issues of re-dispersibility upon application or poor performance of the dispersion in use. Attempts at resolving such problems include adding anti-settling agents, increasing particle loading, etc. These solutions have been only partly successful and may, for example, lead to a significant increase in viscosity that may preclude the dispersion from being useful in some applications such as inks for ink jet printers and spray coating.

Since their discovery in the 1990s, carbon nanotubes have attracted significant interest for many such applications owing to their high strength to weight ratios, high thermal conductivity and good intrinsic electrical conductivity. It is the latter property of carbon nanotubes that has probably attracted most interest as potentially conductive coatings and conductive polymers utilising carbon nanotubes have wide applicability. A typical thermal application is in thermal interface materials for use in cooling mechanisms for electronic components, for example as described in WO 03/054958 or US 2003/0111333.

Carbon nanotubes may be made by a variety of techniques such as arc discharge, chemical vapour deposition or laser ablation as has been widely reported in the literature. The nanotubes may be single-walled nanotubes (SWNT) or multi-walled nanotubes (MWNT), ie tubes having two or more generally concentric walls. The SWNT typically vary from about 1 to 2 nm in diameter, whereas MWNT typically vary from about 5 to 50 nm in diameter. Carbon nanotubes typically have aspect ratios of up to about 100 to 100000, ie they have lengths of around 1 to 100 μm. Carbon nanotubes have also been made with diameters of the order of 100 to 200 nm and lengths of 20 to 100 μm, which, owing to their size and properties, have also been referred to as carbon nanofibres. Carbon nanotubes may vary in geometry, ie they may be straight, curved or bent, and are generally available in mixtures of such geometries. Some forms of carbon nanotubes are provided in a tangled or bundled form, ie they are tangled together in larger structures, although still on a nanoscale size, much like a scouring pad or wire wool in form. In this instance, the larger structures often contain a significant amount of amorphous carbon. Other manufacturing techniques result in aligned carbon nanotubes.

Other applications for carbon nanotubes include flame retardancy applications wherein the nanotubes improve the coherency of the char formed on the surfaces of burning materials thereby reducing or preventing further combustion of the materials. An example of such an application is described in WO 03/078315.

As mentioned above, there are problems in forming suitable stable dispersions of many fine particles and stable dispersions of carbon nanotubes are difficult to achieve. The difficulties are thought to arise because of the well-recognised phenomenon that strong attractive forces exist between carbon nanotubes. The consequence of the strong attractive forces is that the nanotubes tend to exist as agglomerations of nanotubes that are difficult to separate and disperse.

An issue at least partly related to the dispersal of the carbon nanotubes is that a number of applications also require films, coatings or composites containing them to have a high degree of optical transparency, ie the film, coating or composite should be relatively clear in the visible waveband (approximately 700 to 400 nm). The amount of nanotubes present and the dispersal of those nanotubes as individual tubes or ropes of tubes as compared to larger clumps and agglomerates of tubes will affect the transparency and clarity of the resultant material. There have been a number of approaches that attempt to resolve these issues.

For example, WO 02/076888 discloses exfoliating carbon nanotubes, particularly SWNT by coating them with a water-soluble polymer in water. WO 02/076724 and WO 03/024798 disclose using carbon nanotubes dispersed in polymer films. Although the disclosures in these two publications are not limited to the use of SVVNT, they disclose that SWNT, which readily form ropes of tubes, are particularly useful. In particular, WO 02/076724 requires the use of carbon nanotubes that have an outer diameter of less than 3.5 nm.

In an article entitled “Dispersion and film properties of carbon nanofibre pigmented conductive coatings”, J A Johnson et al, Progress in Organic Coatings 47 (2003), 198-206, there is disclosed the preparation of dispersions of carbon nanofibres by exfoliating stacked tetraalkyl ammonium hectorite clay platelets in the presence of nanofibre bundles by sonication in a mixed xylenes solvent. The optimal nanofibre to clay weight ratio reported is 1:1. The result is a highly viscous gel network that, upon the addition of a suitable dispersant/surfactant, is converted to a low viscosity fluid.

In WO 03/078315, polymeric composites are described containing nanotubes which are allegedly homogeneously dispersed with the aid of clays. However, the results relating to the exemplified composites, which are made using extrusion techniques, that, in composites which do not contain clays, the nanotubes are apparently well dispersed and give improved properties, especially in relation to flame retardency.

In an article entitled “Ultra-low electrical percolation threshold in carbon-nanotube-epoxy composites”, J K W Sandler et al, Polymer 44 (2003) 5893-5899, there is disclosed the preparation of dispersions of carbon nanotubes in epoxy resin by intensive shear mixing. An article entitled “Organic derivation of single-walled carbon nanotubes by clays and intercalated derivatives”, V Georgakilas et al, Carbon 42 (2004) 865-870 discloses functionalising single-wall carbon nanotubes using smectites clays, in particular a natural Wyoming montmorillonite, to catalyse the reactions.

WO 97/31873, U.S. Pat. No. 4,558,075 and WPI Abstract Accession No 2003-382627 (CN 1384163) disclose using clays in paint and coating compositions.

The Applicant has found that, by using clays surprisingly it is possible to develop stable, film-forming dispersions of fine particles including those of carbon black and carbon nanotubes and coherent films, coatings and composites containing such particles.

It is therefore an objective of the present invention to provide stable dispersions of fine particles and films, coatings and composites made therefrom.

It is another objective of the present invention to provide electrically conductive films, coatings and composites containing dispersed conductive fine particles.

It is yet another objective of the present invention to provide thermally conductive films and composites containing dispersed thermally conductive fine particles.

According to a first embodiment of the present invention, a non-aqueous dispersion comprises an organic solvent comprising at least 50 wt % of said dispersion and a solids component which comprises not more than 20 wt % of said dispersion, said solids component comprising fine particles and an organically-modified layered inorganic species capable of being dispersed by said solvent and, optionally, an organic polymeric species and/or a reactive precursor of an organic polymeric species soluble in said solvent, said polymeric species and/or reactive precursor of a polymeric species when present comprising less than 50 wt % of said solids content.

Preferably, in the dispersion according to the first embodiment of the invention, the solvent comprises at least 70 wt % of said dispersion.

Preferably, in the dispersion according to the first embodiment of the invention, the solids component comprises not more than 15 wt % of said dispersion and more especially not more than 10 wt % of said dispersion. In particular, the solids component comprises not more than 5 wt % of said dispersion. Preferably, the solids component comprises at least 0.1 wt %, more preferably at least 0.5 wt % of said dispersion.

Preferably, in the dispersion according to the first embodiment of the invention, said polymeric species and/or reactive precursor of a polymeric species when present comprises less than 35 wt % of said solids content and more especially less than 25 wt % of said solids content. Preferably, the polymeric species and/or a reactive precursor of a polymeric species when present comprises at least 1 wt % of said solids content, more preferably at least 5 wt % of said solids content, and especially at least 10 wt % of said solids content.

According to a second embodiment of the present invention, a non-aqueous dispersion comprise a liquid reactive precursor of an organic polymeric species comprising at least 50 wt % of said dispersion and a solids component which comprises not more than 20 wt % of said dispersion, said solids component comprising fine particles and an organically-modified layered inorganic species capable of being dispersed by said reactive precursor.

Preferably, in the dispersion according to the second embodiment of the invention, the solids component comprises not more than 15 wt % of said dispersion and more especially not more than 10 wt % of said dispersion. In particular, the solids component comprises not more than 5 wt % of said dispersion. Preferably, the solids component comprises at least 0.1 wt %, more preferably at least 0.5 wt % of said dispersion.

The fine particles used in the present invention may be metal, including metal alloys and layered metals, and metal oxide particles, eg gold, silver, copper, silver-coated copper, indium tin oxide, titanium dioxide; carbon particles eg carbon black, graphite, carbon nanotubes, carbon nanowhiskers, fullerenes; conductive polymers; and other functional and non-functional fillers and additives such as boron nitride, silica and glass; colourants, pigments, curing agents, catalysts and encapsulant systems.

Depending on the type of particle used, the properties of dispersions and/or final products may be influenced and changed from those obtained in the absence of such fine particles. For example, the electrical, magnetic and thermal properties of materials may be altered. Additionally, or alternatively, the mechanical properties such as modulus, toughness, coefficient of thermal expansion etc may be modified. Alternatively, the particles may be curing agents or catalysts or encapsulated versions (for triggered or delayed release systems) of such particles, antioxidants, flame retardants etc wherein the chemical and/or physical effect of such particles is improved because of an increased dispersability or stability of dispersion. Similarly, the effects of fine particles such as colourants, pigments, opacifiers and opalescants are enhanced by increased dispersability or stability of dispersion of such particles.

In preferred forms of the first and second embodiments of the present invention, the fine particles are selected from electrically-conductive particles; more especially the fine particles are selected from metal and metal oxide particles and/or carbon particles. In an especially preferred form of the first and second embodiments of the present invention, the fine particles are carbon particles; more especially, carbon nanotubes or carbon black and particularly carbon nanotubes.

The carbon nanotubes used in the invention may be SWNT, MWNT or carbon nanofibres. Preferably, however, MWNT are used in the present invention. The SWNT typically vary from about 1 to 2 nm in diameter and lengths of between 0.5 μm to 100 μm. The MWNT typically vary from about 5 to 50 nm in diameter and may have lengths of between 0.5 μm to 200 μm. The carbon nanotubes typically have aspect ratios of up to about 100 to 100000. The carbon nanofibres typically have diameters of the order of 100 to 200 nm and lengths of 20 to 100 μm. The carbon nanotubes used in the invention may vary in geometry, ie they may be straight, curved or bent, and are generally available in mixtures of such geometries. Some forms of carbon nanotubes are provided in a tangled or bundled form, ie they are tangled together in larger structures, although still on a nanoscale size, much like a scouring pad or wire wool in form. In this instance, the larger structures often contain a significant amount of amorphous carbon. Aligned carbon nanotubes may also be used in the invention.

The organically-modified layered inorganic species may be natural or synthetic species and, in particular, include organoclays, especially 2:1 phyllosilicate clays, layered double hydroxides, 2:1 layered transition metal oxides, such as titanates, niobates, and sulphides, layered silicic acid, such as kanemite, magadiite, layered metal phosphates, phosphonates and arsenates and perovskite-type metal halides.

In a preferred embodiment of the present invention, the organically-modified layered inorganic species is an organoclay. Preferably, the organoclay comprises an organically modified 2:1 layered phyllosilicate, especially a 2:1 layered phyllosilicate in which the octahedral sheet sandwiched between the tetrahedral silica sheets is of dioctahedral character and particularly the organoclay is an organically-modified montmorillonite.

Alternatively, the organically-modified layered inorganic species is a modified layered double hydroxide. Layered double hydroxides may be synthetic and naturally occurring lamellar hydroxides in which modifiers may be incorporated in the interlayer region. An example of a general formula for LDH is:

[M₁₋ₓ²⁺Mₓ³⁺(OH)₂]^{y+}A_{y/m}^{m-}.nH₂O

where M²⁺ is a divalent cation such as Mg²⁺, M³⁺ is a trivalent cation such as Al³⁺ and A^{m-} is the interlayer anion such as NO³⁻. In the organically-modified LDH, such anions as NO³⁻ are substituted by suitable organic anions. The value for x is typically in the range 0.2 to 0.33. The LDH should be selected for compatibility with the liquid organic medium.

In the formula:

M²⁺ is preferably selected from Mg²⁺, Cu²⁺, Zn²⁺, Mn²⁺, Fe²⁺, Co²⁺, Ni²⁺
M³⁺ is preferably selected from Al³⁺, Fe³⁺, Cr³⁺, Co³⁺, In³⁺
A^{m-} is preferably of the general formula:

R—B^{m-}

where B^{m-} denotes an anion such as sulphate, sulphonate, carboxylate or toluate and R denotes an organic aliphatic or aromatic structure with typically more than 4 carbon atoms.

The organically-modified layered inorganic species is modified wherein the interlayer metal cations or the interlayer inorganic anions have been exchanged by organic cations and organic anions, respectively, to render the inorganic species organophilic and, in particular, compatible with the organic medium.

Suitable organic cation species are protonated organoammonium or organophosphonium cations, especially organoammonium cations.

Suitable organic anion species are of formula A^{m-} as defined above.

When the layered inorganic species is an organoclay, the clay may by organically modified by chemically grafting organic modifiers onto the surface of the clay platelets.

Preferably, when the inorganic species is an organoclay the organoclay used in the invention is a silicate clay and more particularly is a silicate clay that is a natural or synthetic planar, hydrous, layered phyllosilicate. In particular, the silicate clay is a 2:1 layered phyllosilicate with hydrated exchangeable cations, examples of which are vermiculites and smectites, examples of the latter being montmorillonite, beidellite, nontronite, volkonskoite, saponite, hectorite, fluorohectorite, sauconite, stevensite and swinefordite. More especially, the 2:1 layered phyllosilicates useful in the invention have a dioctahedral character, which includes montmorillonite, beidellite, nontronite and volkonskoite and dioctahedral vermiculite. Most preferred is montmorillonite. Typically, reported aspect ratios for some of the clays are: for hectorite (50), for saponite (150), for montmorillonite (200), and for synthetic fluorohectorite (1500-2000).

In this embodiment, preferably, the organoclay is modified by organoammonium or organophosphonium cations. Preferably, the organic groups of the organoammonium or organophosphonium cations are selected from mixtures of alkyl, hydroxyalkyl, alkenyl and aryl groups. The alkyl groups may be selected from alkyl chains of C₁ to C₂₀ and may be mixtures thereof. In particular, the alkyl groups may be mixtures of short and long chain alkyl groups. Preferably, the short chain alkyl groups are C₁ to C₆ and the long chain alkyl groups are C₇ to C₂₀. Preferably, the hydroxyalkyl group is selected from C₁ to C₆ hydroxyalkyl groups, more especially from C₁ to C₃ hydroxyalkyl groups. Preferably the alkenyl group is selected from C₁₀ to C₂₀ alkenyl groups, more especially from C₁₄ to C₁₈ alkenyl groups. Preferably, the aryl group is phenyl. It is preferred that at least a proportion of the organic groups are derived from tallow and/or hydrogenated tallow. Tallow is a natural product composed predominantly of C₁₈ (65%), C₁₆ (30%), and C₁₄ (5%) alkenyl chains. In hydrogenated tallow, the majority of the double bonds in the alkenyl chains have been hydrogenated. The organic groups may themselves be terminated with reactive end groups such as hydroxy, amine, epoxy etc, including groups reactive in response to incident radiation such as UV radiation.

Preferably, the spacing between the layers in the clay (derived from the characteristic Bragg reflection peak of d₀₀₁) is greater than 1.2 nm and, more particularly is at least 1.5 nm.

When the inorganic species is an organically-modified LDH, preferably the anions are selected from fatty acids and alkyl, aryl or alkaryl sulphates or sulphonates or mixtures thereof. Particular examples of suitable anions are dodecyl sulphate, dodecylbenzene sulphonate or styrene sulphonate.

The liquid organic medium used in the invention is capable of at least dispersing the organically-modified layered inorganic species. More preferably, the organically-modified layered inorganic species is also, at least to some extent, intercalated and/or exfoliated by the liquid organic medium.

As described above, the dispersions of the first and second embodiments of the present invention utilise an organic solvent or a liquid reactive precursor of a polymer (for convenience, hereinafter “a liquid organic medium” when the context permits its use).

When the organically-modified layered inorganic species is intercalated and/or exfoliated by the liquid organic medium, the resultant organically-modified layered inorganic species dispersion is essentially optically transparent under an optical microscope.

It will be appreciated that, in relatively high viscosity systems, the viscosity of the liquid organic medium is sufficient to prevent significant settlement of the organically-modified layered inorganic species and, of course, the fine particles.

However, in relatively low viscosity systems, depending upon the degree of intercalation and/or exfoliation of the organically-modified layered inorganic species, some settlement may occur. This phenomenon provides a simple measure of the effectiveness of the liquid organic medium in intercalating and/or exfoliating the organically-modified layered inorganic species.

In preferred dispersions according to the invention, the organically-modified layered inorganic species, preferably an organoclay or modified LDH, and the liquid organic medium combinations are selected to have, in accordance with the simple test described below, a settled volume of at least 50% or higher as specified below.

Depending upon the degree of intercalation and/or exfoliation of the organically-modified layered inorganic species by the liquid organic medium, some settlement may occur. This phenomenon provides a simple screen of the effectiveness of the organic medium in intercalating and/or exfoliating the organically-modified layered inorganic species. The fact that this screen is an effective indicator for organically-modified layered inorganic species/organic medium combinations was confirmed by examining some organically-modified layered inorganic species/organic medium dispersions using X-ray diffraction.

Thus, as described in more detail below, after mixing a fixed weight, suitably 2%, of organically-modified layered inorganic species with the liquid organic medium and allowing the resultant mixture to stand for a settlement period, suitably 4 days (96 hours), the settled volume may be measured. For ease of measurement, the mixture is placed in standard vials and the height of the settled volume is measured and is expressed as a percentage of the total height of the mixture.

By using this simple test, suitable low viscosity liquid organic media are media that intercalate and/or exfoliate the organically-modified layered inorganic species to the extent that the resultant settled volume is at least 50%, more preferably is at least 60%, more particularly is at least 70% of the total height of the mixture. In particularly preferred embodiments of the invention, suitable low viscosity liquid organic media are media that intercalate and/or exfoliate the organically-modified layered inorganic species to the extent that the resultant settled volume is at least 75%, more preferably is at least 80%, more particularly is at least 90% and is especially 100% of the total height of the mixture.

With regard to the first embodiment, the organic solvent may be selected from a wide range of organic solvents such as aliphatic, including cyclic aliphatic, and aromatic hydrocarbons, including substituted hydrocarbons, for example halogen-substituted hydrocarbons, alcohols, ethers, including cyclic, aromatic and aromatic-aliphatic ethers, aliphatic, cyclic aliphatic, aromatic or heterocyclic carbonyl compounds (more particularly ketones), aliphatic and aromatic esters and alkoxyesters (particularly C₁ to C₆ alkoxyesters) (eg propyl acetate) and mixtures thereof. More preferably, the organic solvent is selected from aliphatic and aromatic hydrocarbons, including halogen-substituted hydrocarbons, ethers, including cyclic, aromatic and aromatic-aliphatic ethers, aliphatic or heterocyclic ketones, aliphatic and aromatic esters and alkoxyesters (particularly C₁ to C₆ alkoxyesters) and mixtures thereof. Particularly preferred organic solvents for use in the invention are selected from the group consisting of iso-hexane, methyl cyclohexane, methyl cyclohexane, toluene, xylene, chloroform, acetone, methyl ethyl ketone, N-methyl-2-pyrrolidone, tetrahydrofuran, anisole, methyl benzoate, 2-butoxyethylacetate, 2-ethoxyethylacetate and mixtures thereof.

In one form of the first embodiment of the invention, it is preferred that, when the organically-modified layered inorganic species is an organoclay that contains an aryl group, the solvent also contains an aryl group.

With regard to the second embodiment of the invention, the liquid reactive precursor of a polymer may be selected from monomeric and/or oligomeric precursors. The reactive precursors may include appropriate initiators, catalysts etc or, alternatively, such components may be added at a later stage. The reactive precursors, together with the appropriate trigger component, may be polymerisable using heat or radiation or the reactive precursors may be polymerisable on the addition of the appropriate trigger component.

The reactive precursor is preferably a thermosetting resin and may be selected from the group consisting of an epoxy resin, an addition-polymerisation resin, especially a bis-maleimide resin, a formaldehyde condensate resin, a phenolic resin and mixtures of two or more thereof; and, more especially, is preferably an epoxy resin derived from the mono or poly-glycidyl derivative of one or more of the group of compounds consisting of aromatic diamines, aromatic monoprimary amines, aminophenols, polyhydric phenols, polyhydric alcohols, polycarboxylic acids and the like, or a mixture thereof, a cyanate ester resin, or a phenolic resin. Examples of addition-polymerisation resin are acrylics, vinyls, bismaleimides, and unsaturated polyesters. Examples of formaldehyde condensate resins are urea, melamine and phenols.

According to one form of the second embodiment of the invention, the reactive precursor preferably comprises at least one epoxy, cyanate ester or phenolic resin precursor, which is liquid at ambient temperature; for example as disclosed in EP-A-0311349, EP-A-0365168, EP-A-91310167.1 or in PCT/GB95/01303. Preferably the reactive precursor is an epoxy resin precursor.

Suitable epoxy resin precursors may be selected from N,N,N′N′-tetraglycidyl diamino diphenylmethane (eg “MY 9663”, “MY 720” or “MY721” sold by Ciba Geigy) viscosity 10-20 Pa s at 50° C.; (MY721 is a lower viscosity version of MY720 and is designed for higher use temperatures; N,N,N′N′-tetraglycidyl-bis(4-aminophenyl)-1,4-diiso-propylbenzene (eg Epon 1071 sold by Shell Chemical Co.) viscosity 18-22 Poise at 110° C.; N,N,N′N′-tetra-glycidyl-bis(4-amino-3,5-dimethylphenyl)-1,4-diisopropylbenzene, (eg Epon 1072 sold by Shell Chemical Co.) viscosity 30-40 Poise at 110° C.; triglycidyl ethers of p-aminophenol (eg “MY 0510” sold by Ciba Geigy), viscosity 0.55-0.85 Pa s at 25° C.; preferably of viscosity 8-20 Pa at 25° C.; preferably this constitutes at least 25% of the epoxy components used; diglycidyl ethers of bisphenol A based materials such as 2,2-bis(4,4′-dihydroxy phenyl) propane (eg “DER 661” sold by Dow, or “Epikote 828” sold by Shell), and Novolak resins preferably of viscosity 8-20 Pa s at 25° C.; glycidyl ethers of phenol Novolak resins (eg “DEN 431” or “DEN 438” sold by Dow), varieties in the low viscosity class of which are preferred in making compositions according to the invention; diglycidyl 1,2-phthalate, eg GLY CEL A-100; diglycidyl derivative of dihydroxy diphenyl methane (Bisphenol F) (eg “PY 306” sold by Ciba Geigy) which is in the low viscosity class. Other epoxy resin precursors include cycloaliphatic such as 3′,3′ epoxycyclohexyl-3,4-epoxycyclohexane carboxylate (eg “CY 179” sold by Ciba Geigy) and those in the “Bakelite” range of Union Carbide Corporation.

Epoxy resin precursors that have relatively high viscosities may be used in combination with appropriate diluents, such as oxetenes, that lower the viscosities of the system but are incorporated into the resin matrix on curing.

Suitable cyanate ester resin precursors may be selected from one or more compounds of the general formula NCOAr(ZyArx)nOCN and oligomers and/or polycyanate esters and combinations thereof wherein Ar is a single or fused aromatic or substituted aromatic and combinations thereof and there between nucleus linked in the ortho, meta and/or para position and y=0 up to 2 and x and n=0 to 5 independently. The Z is a linking unit selected from the group consisting of oxygen, carbonyl, sulphur, sulphur oxides, chemical bond, aromatic linked in ortho, meta and/or para positions and/or CR₂ wherein R₁ and R₂ are hydrogen, halogenated alkanes, such as the fluorinated alkanes and/or substituted aromatics and/or hydrocarbon units wherein said hydrocarbon units are singularly or multiply linked and consist of up to 20 carbon atoms for each R₁ and/or R₂ and P(R₃ R₄ R′₄ R₅) wherein R₃ is alkyl, aryl, alkoxy or hydroxy, R₁₄ may be equal to R₄ and a singly linked oxygen or chemical bond and R₅ is doubly linked oxygen or chemical bond or Si(R₃ R₄ R′₄ R₅) wherein R₃ and R₄ R′₄ are defined as in P(R₃ R₄ R′₄ R₅) above and R₅ is defined similar to R₃ above. An example of which would be the Arocy range of cyanate esters sold by Ciba Geigy. Optionally, the thermoset can consist essentially of cyanate esters of phenol/formaldehyde derived Novolaks or dicyclopentadiene derivatives thereof, an example of which is XU71787 sold by the Dow Chemical Company.

According to another form of the second embodiment of the invention, the reactive precursor preferably comprises an addition-polymerisation resin precursor.

More specifically, the reactive precursor comprises at least one (meth)acrylate precursor preferably selected from alkyl esters of acrylic acid or methacrylic acid or mixtures thereof. Preferably, the alkyl group of the esters is selected from C1 to C18 alkyl, including cyclic alkyl groups, more particularly C1 to C14 and especially C1 to C10. The reactive precursor may by a single (meth)acrylate ester or a mixture of (meth)acrylate esters. Additionally, the final reactive mixture prepared using the dispersion according to the invention may contain minor proportions of other reactive species depending on the final polymer properties required. Examples of such other reactive species are acrylic and methacrylic acids, other (meth)acrylate esters, vinylic compounds including styrene and derivatives thereof. Free-radical initiators for triggering the polymerisation of the (meth)acrylate precursors include azo compounds and peroxide compounds. The dispersion, according to the invention, consisting of (meth)acrylates, with or without other reactive species but including initiators, may be cast or otherwise formed into a film and then polymerised, for example by heating or incident radiation. Alternatively, the dispersion, according to the invention, consisting of (meth)acrylates, with or without other reactive species but including initiators, may be emulsion or suspension polymerised and the resultant polymer beads and/or particles injection moulded or formed into films.

Suitable bismaleimide resin precursors are heat-curable precursors containing the maleimido group as the reactive functionality. The term bismaleimide as used herein includes mono-, bis-, tris-, tetrakis-, and higher functional maleimides and their mixtures as well, unless otherwise noted. Bismaleimide resins with an average functionality of about 2 are preferred. Bismaleimide resins as thusly defined are prepared by the reaction of maleic anhydride or an aromatic or aliphatic di- or polyamine. Examples of the synthesis may be found for example in U.S. Pat. Nos. 3,018,290, 3,018,292, 3,627,780, 3,770,691 and 3,839,358.

Preferred di- or polyamine precursors include aliphatic and aromatic diamines. The aliphatic diamines may be straight chain, branched, or cyclic, and may contain heteroatoms. Examples of such aliphatic diamines are hexanediamine, octanediamine, decanediamine, dodecanediamine, and trimethylhexanediamine.

The aromatic diamines may be mononuclear or polynuclear, and may contain fused ring systems as well. Preferred aromatic diamines are the phenylenediamines; the toulenediamines; the various methylenediamines, particularly 4,4′-methylenedianiline; the naphtalanediamines; the various amino-terminated polyarylene oligomers corresponding to or analogues to the formula H₂N—Ar[X—Ar]ₙNH₂, wherein each Ar may individually be a mon- or poly-nuclear arylene radical, each X may individually be —O—, —S—, CO₂—, —SO₂—, —O—CO—, C₁-C₁₀ lower alkyl, C₁-C₁₀ halogenated alkyl, C₂-C₁₀ lower alkyleneoxy, aryleneoxy, polyalkylene or polyoxyarylene, and wherein n is an integer of from 1 to 10; and primary aminoalkyl terminated di- and polysiloxanes. An example of which would be the Matrimid range of Bismaleimides sold by Ciba Geigy and Homide range sold by Hos-technik.

Particularly useful are bismaleimide “eutectic” resin precursor mixtures containing several bismaleimides. Such mixtures generally have melting points, which are considerably lower than the individual bismaleimides. Examples of such mixtures may be found in U.S. Pat. Nos. 4,413,107 and 4,377,657. Several such eutectic mixtures are commercially available and include the BT Resins as sold by Mitsubishi.

The polyurethane precursors are polyfunctional (ie at least di-functional) isocyanates and polyols or other reactant species that contain two or more groups reactive with isocyanate groups. The isocyanate reactive precursor may be aliphatic, cycloaliphatics, aronnatic or polycyclic. The polyols and/or other reactive species, which include polyester polyols and polyethers, are able to react with the isocyanate precursor, in the presence of suitable catalysts, to form polyurethanes.

As described previously, dispersions according to the invention preferably contain not more than 20 wt % solids component, more preferably not more than 15 wt% solids component and more especially not more than 10 wt % solids component. In preferred forms of the invention, the dispersions contain not more than 5 wt % solids component. Preferably, the dispersion contain at least 0.1 wt %, more preferably at least 0.5 wt % of solids component. Typically, the dispersions contain between 1 to 3 wt % solids component.

The weight ratio of fine particles to organically-modified layered inorganic species in dispersions according to the invention will vary depending upon the application for which the dispersions are intended. The weight ratio of fine particles to organically-rnodified layered inorganic species in such dispersions may be in the range 99:1 to 1:99 More preferably the ratio is not more than 90:10, more especially is not more than 80:20 and may be 50:50 or less. Conversely, the ratio is preferably not less than 10:90, and more especially is not less than 20:80.

The dispersions according to the invention may contain other components depending upon the application. For example the dispersions may contain mixtures of fine particles, antioxidants, fillers, plasticisers, reinforcing materials, tougheners and similar additives as are well known in the art. When formulations are adjusted to include such other components, the solids component limits as described above apply to all of the solids added.

Dispersions according to the invention may also contain a polymeric species and/or a reactive precursor of a polymeric species, especially the dispersion according to the first embodiment of the invention. The polymeric species and/or a reactive precursor of a polymeric species may be soluble in the liquid organic medium or, when a reactive precursor of a polymeric species, may be liquid.

The polymeric species may be derived from thermosetting polymers, thermoplastic polymers, elastomers and mixtures thereof that are soluble in the liquid organic medium. The polymers may be selected from polyalkylenes, polyvinyl polymers, polyurethanes, polyamides, polyethers, polyimides, polyesters, poly(meth)acrylates, bismaleimide resins, cyanate ester resins, phenol-formaldehyde resins and polyoxazolines. In some applications, polymers useful in this embodiment of the invention may be selected from at least one of the group consisting of thermoplastic acrylic, vinyl, urethane, alkyd, polyester, hydrocarbon, fluoroelastomer and celluosic resins; and, thermosetting acrylic, polyester, epoxy, urethane, and alkyd resins. The polymeric species may be made by mixing a dispersion of fine particles and organically modified layered inorganic species in a solvent with the polymer either by dissolving the polymer in the dispersion or by mixing a separate solution of the polymer with the dispersion. The resultant polymer solution containing the dispersed fine particles may then formed into a film by any suitable process such as solvent casting, spin coating, doctor blade etc. Solvent removal may be accelerated by any conventional means, for example the application of heat, reduced pressure etc.

The reactive precursor of a polymeric species may be derived from reactive precursors that are compatible with the liquid organic medium. When the liquid organic medium is itself a reactive precursor, the reactive precursor of a polymeric species may be copolymerisable with said reactive precursor or may form a separate polymeric species. The reactive precursor of a polymeric species may be, as previously described, those reactive precursors may be selected from precursors for addition-polymerisation resins (such as (meth)acrylates, bismaleimides, and unsaturated polyesters), epoxide resins, cyanate ester resins, isocyanate resins (polyurethanes) or formaldehyde condensate resins (such as urea, melamine or phenols) or mixtures thereof.

In the first embodiment of the invention wherein the dispersion comprises a solvent, the polymeric species and/or a reactive precursor of a polymeric species functions as a binder for the fine particles in films and other structures following removal of the solvent therefrom.

Dispersions according to the invention are particularly useful for applications such as inks, paints, forming films and coatings.

Dispersions according to the invention have particular utility. Such dispersions are of low viscosity and may have their viscosity “tuned” to a particular application. For example, simply increasing the fine particles/organoclay content will increase the viscosity of the dispersions. Thus, low viscosity dispersions may be utilised in ink jet and spray coating applications; medium viscosity dispersions may be utilised in dip coating applications and higher viscosity dispersions may be utilised in calandering, screen printing and doctor blade film formation applications.

Thus, according to a third embodiment of the present invention, a structure comprises fine particles and an organically-modified layered inorganic species and, optionally, an organic polymeric component which, when present, comprises less than 50 wt % of the combined total weight of the particles and the species.

Also, according to a fourth embodiment of the present invention structure comprising fine particles which are high aspect ratio particles and an organically-modified layered inorganic species and, optionally, an organic polymeric component which, when present, comprises less than 50 wt % of the combined total weight of the particles and the species, wherein the fine particles are at least partially oriented.

In such structures according to the third and fourth embodiments of the present invention, the fine particles are selected from metal and metal oxide particles, carbon particles, conductive polymeric particles; functional and non-functional fillers and additives, colourants, pigments, curing agents, catalysts and encapsulant systems.

More particular, in such structures, the fine particles are selected from electrically-conductive particles and are preferably selected from metal and metal oxide particles and/or carbon particles. In especially preferred structures according to the invention, the fine particles are carbon particles, particularly carbon particles selected from carbon nanotubes or carbon black.

In preferred forms of the third and fourth embodiments of the invention, the fine particles are carbon nanotubes.

A preferred structure in accordance with the third and fourth embodiments of the invention consists essentially of said fine particles and said species.

In alternative forms of the third and fourth embodiments of the invention, when the polymeric species is present, it comprises less than 35 wt % of the structure and more especially less than 25 wt % of the structure. Preferably, the polymeric species comprises at least 1 wt % of the structure, more preferably at least 5 wt % of the structure and especially at least 10 wt % of the structure.

According to a fifth embodiment of the present invention, a structure comprises electrically-conductive fine particles and an organically-modified layered inorganic species and an organic polymeric component which comprises at least 50 wt % of the total weight of the structure, wherein said structure has an electrical percolation threshold lower than and/or a transparency greater than an equivalent structure in which the organically-modified layered inorganic species is absent.

In preferred forms of the structure according to the fifth embodiment of the invention, the polymeric component comprises not less than 80 wt %, more preferably not less than 85 wt % and more especially not less than 90 wt % of the structure. More especially, the polymeric component comprises not less than 95 wt % of the structure. Typically, the polymeric matrix is between 97 to 99 wt % of the structure.

In preferred forms of the structure according to the fifth embodiment of the invention, the fine particles are preferably selected from metal and metal oxide particles and/or carbon particles. In especially preferred structures according to the fifth embodiment of the invention, the fine particles are carbon particles, particularly carbon particles selected from carbon nanotubes or carbon black and, more especially, the fine particles are carbon nanotubes.

As will be appreciated, the organically-modified layered inorganic species in the structures according to the invention are as described hereinbefore in relation to the dispersions according to the invention.

The structures according to the invention may be a film. The film may be continuous, ie have significant width and length relative to its depth, or it may be discontinuous, ie have insignificant width relative to its length and/or depth. In the latter form, the film may be laid out similar to an electrical or electronic circuit or form connections between components for such circuits. Film thicknesses may be of the order of 1 to 40 μm although thicker films may also be made. Such films may have electrical conductivities in the range 10⁻⁷ to 100 S cm⁻¹; more especially, the films may have a conductivity of at least 1 S cm⁻¹, more preferably at least 10 S cm⁻¹ and particularly at least 50 S cm⁻¹.

Structures according to the invention are preferably abrasion resistant.

When the structure according to the invention comprises conductive fine particles, preferably the weight ratio of fine particles to organically-modified-layered inorganic species is in the range 99:1 to 10:90. Preferably, the ratio is not more than 90:10, more preferably not more than 80:20 and more particularly is not more than 70:10. Preferably, at the other end of the range, the ratio is at least 10:90 and, more preferably, is at least 20:80 and more especially is 30:70. Thus, preferred ranges for the weight ratio of fine particles to organically-modified layered inorganic species are 90:10 to 10:90, more preferably 70:30 to 20:80, more particularly. 70:30 to 30:70. A particularly preferred range is 70:30 to 60:40.

Structures according to the invention may be free standing or supported on a suitable substrate. The substrate itself may be conducting or non-conducting and includes substrates made of polymers, both organic and inorganic, inorganic materials and metals. The structures according to the invention may be formed on the surfaces of other structures or may be integral therewith, the dispersions according to the invention having been used to impregnate such other structures, for example fabrics to form a prepreg. The structures according to the invention may form part of a multilayered structure, for example a laminate consisting of two or more layers. The other layers may be insulating or conductive and, in the latter instance, may contain or consist of other conductive materials.

The invention will now be described by way of illustration only with reference to the following Examples and the accompanying drawings, of which:

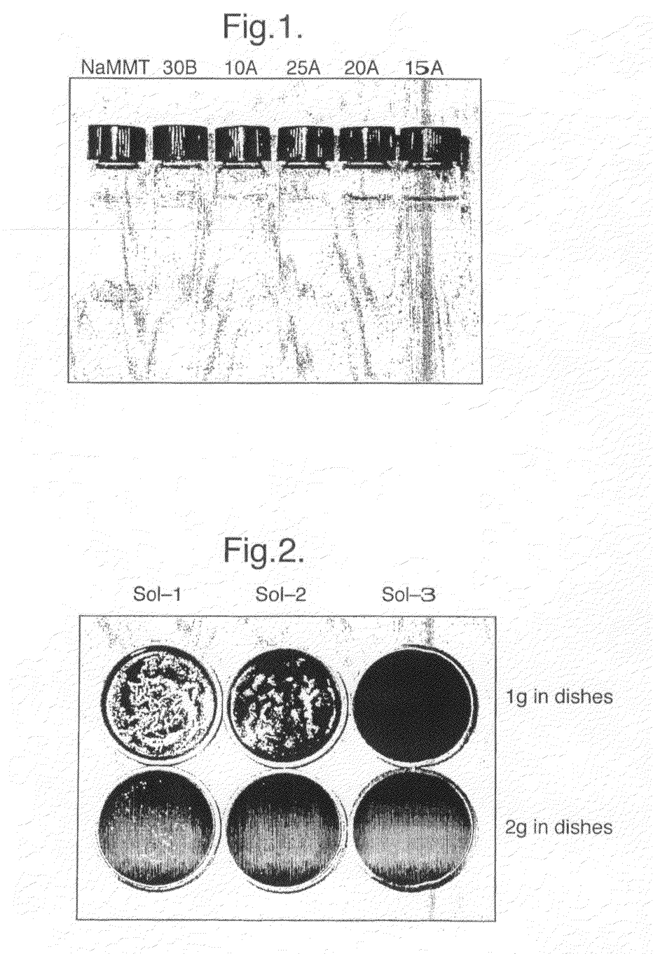

FIG. 1 is a photograph of a set of vials containing samples of dispersions as described in Example 1;

FIG. 2 is a set of photographs of carbon nanotube films as described in Example 2; and

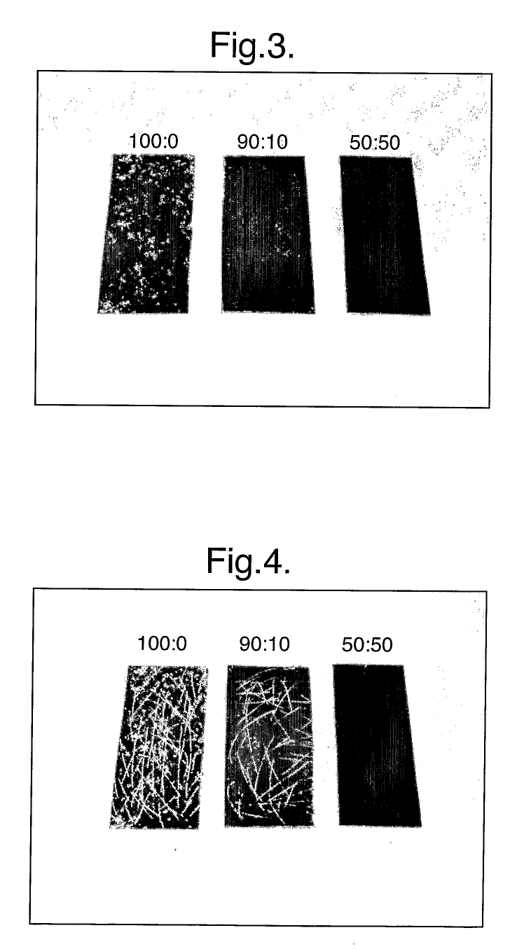

FIGS. 3 and 4 are photographs of carbon nanotube films as described in Example 3;

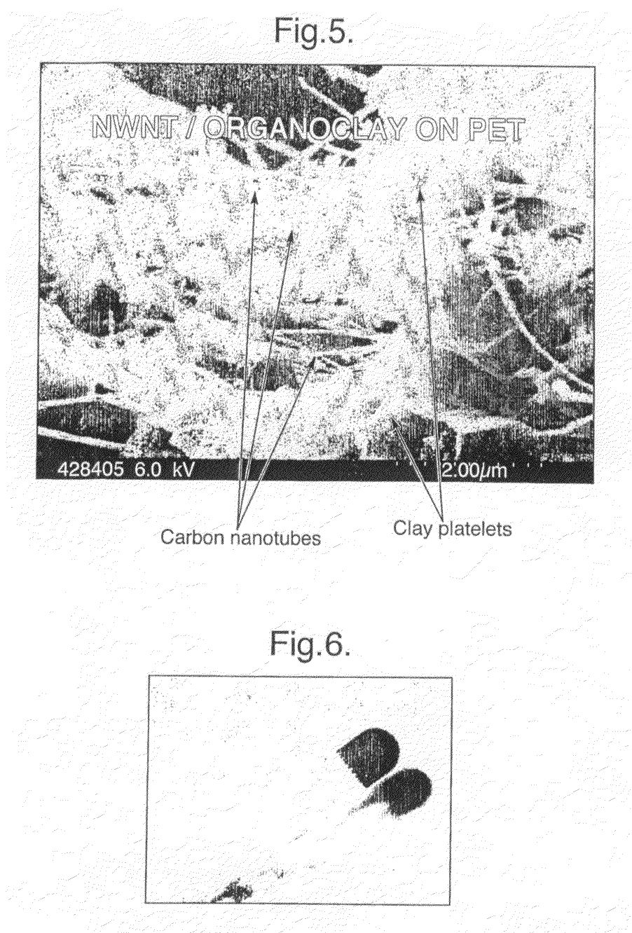

FIG. 5 is a scanning electron micrograph of one of the films described in Example 3;

FIG. 6 is a photograph of a probe having a film dip-coated on one end as described in Example 6;

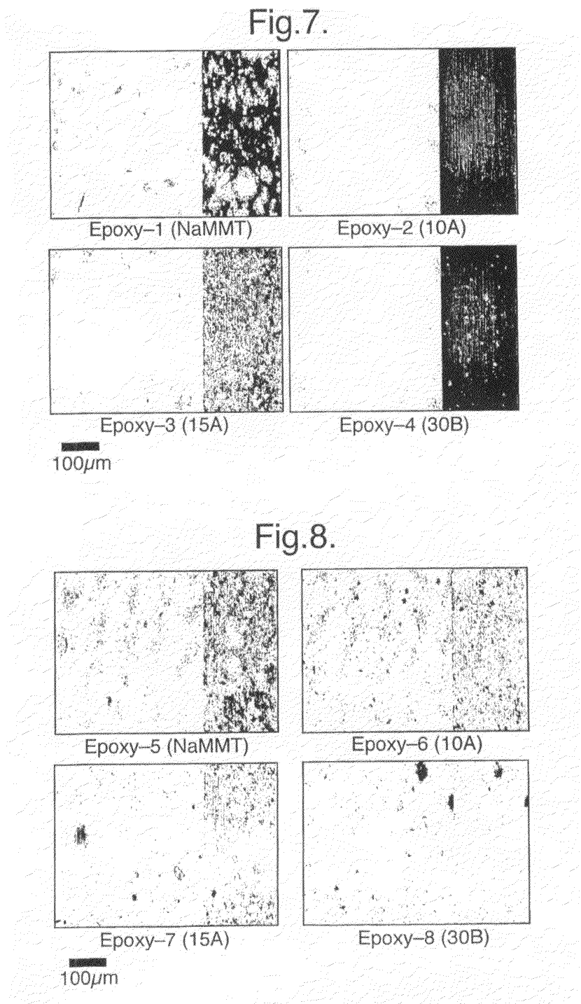

FIG. 7 is micrographs of Samples Epoxy-1 to Epoxy-4 as identified in Example 8, the micrographs each showing the sample in non-polarised (left hand side) and polarised light (right hand side);

FIG. 8 is micrographs of Samples Epoxy-5 to Epoxy-7 as identified in Example 8, the micrographs each showing the sample in non-polarised (left hand side) and polarised light (right hand side);

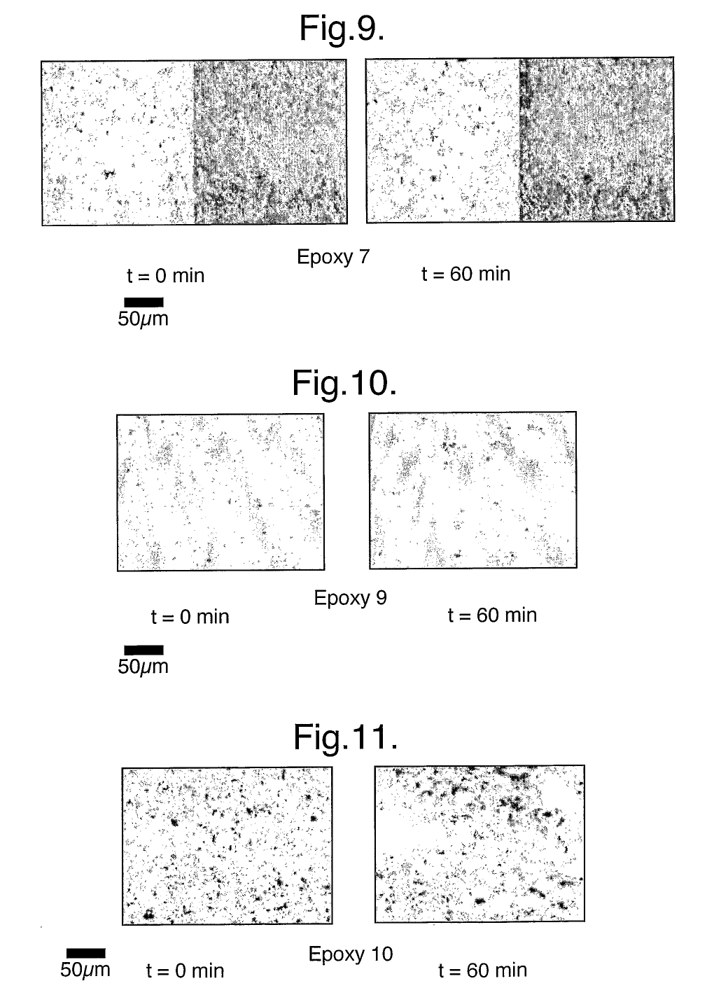

FIG. 9 is micrographs of Sample Epoxy-7 as identified in Example 8, the micrographs each showing the sample in non-polarised (left hand side) and polarised light (right hand side);

FIG. 10 is micrographs of Sample Epoxy-9 as identified in Example 8, the micrographs each showing the sample in non-polarised light;

FIG. 11 is micrographs of Sample Epoxy-10 as identified in Example 8, the micrographs each showing the sample in non-polarised light;

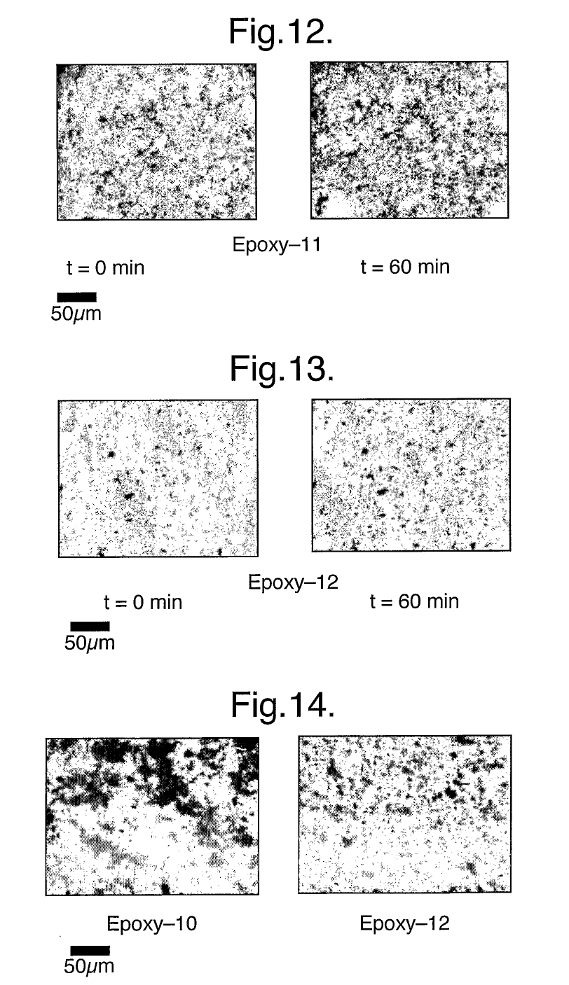

FIG. 12 is micrographs of Sample Epoxy-11 as identified in Example 8, the micrographs each showing the sample in non-polarised light;

FIG. 13 is micrographs of Sample Epoxy-12 as identified in Example 8, the micrographs each showing the sample in non-polarised light;

FIG. 14 is micrographs of cured films of Samples Epoxy-10 and 12 as identified in Example 8, the micrographs each showing the sample in non-polarised light;

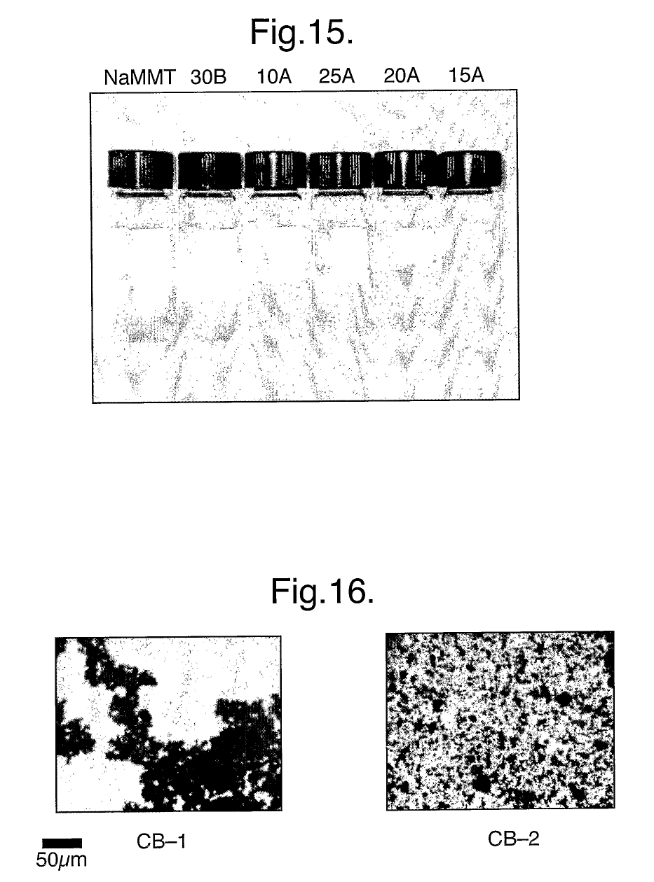

FIG. 15 is a photograph of a set of vials containing samples of dispersions as described in Example 10;

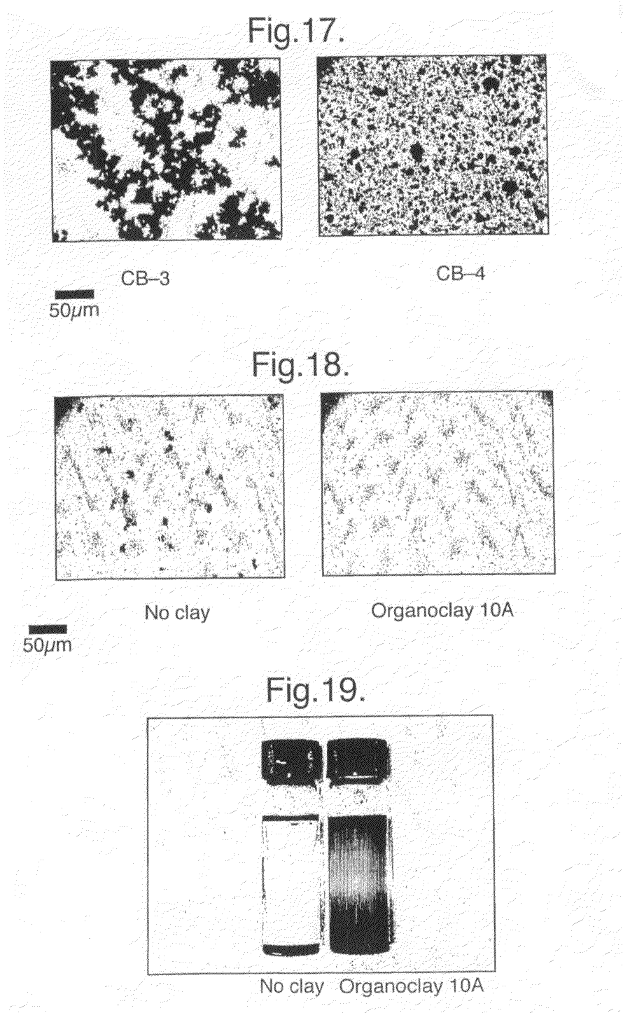

FIGS. 16 and 17 are micrographs of the Samples identified in Example 12;

FIG. 18 are micrographs of Samples identified in Example 13; and

FIG. 19 is a photograph of a set of vials containing samples of dispersions as described in Example 14.

### EXAMPLES

In the Examples below, the following particulate materials were used:

### Carbon Nanotubes

The carbon nanotubes used in the Examples were as detailed in Table 1. The MWNT were all obtained by chemical vapour deposition process route (CVD). The SWNT were obtained by a catalytic route.

### Carbon Black

The carbon black used in the Examples was obtained from Degussa and has a mean particle size of around 20 nm.

### Fullerenes

The fullerite (C60:C70 mixture (9:1) precursor to buckminsterfullerenes (C60) and (6,6)-fullerenes (C70)) used in Example 13 was obtained from Aldrich and had a particle size of <1 nm.

TABLE 1

| Carbon | | |
|---|---|---|
| Nanotube | | |
| Designa- | Type of Carbon | |
| tion | Nanotube | Supplier |
| CNT-A | MWNT: 99% carbon; | Carbon Nanotech Research |
| | outer diameter: 20 nm; | Institute (CNRI, Tokyo, |
| | length: few microns | Japan), a subsidiary of |
| | | Mitsui & Co., Ltd |
| CNT-B | MWNT (Long): 95% carbon | Nanostructured & Amorphous |
| | Outer diameter: 20-30 nm | Materials, Inc. (Los Alamos, |
| | Length: 0.5-200 μm | New Mexico, USA) |
| CNT-C | MWNT (Short): 95% carbon | Nanostructured & Amorphous |
| | Outer diameter: 10-30 nm | Materials, Inc. (Los Alamos, |
| | Length: 10-30 μm | New Mexico, USA) |
| CNT-D | SWNT: 90% carbon | Nanostructured & Amorphous |
| | Outer diameter: 1-2 nm | Materials, Inc. (Los Alamos, |
| | Length: 0.5-100 μm | New Mexico, USA) |

### Indium Tin Oxide

The indium tin oxide used in Example 7 was generated by the Applicant using a cryogenic process to produce the ITO particles. The ITO particles had a particle size of around 30 nm but they tend to agglomerate and produce agglomerates of around a few microns in size.

### Polyaniline

The conductive polyaniline PANI used in Example 14 was obtained from Aldrich (emeraldine salt, av MW>15000. infusible powder having a particle size range 3-100 μm.

### Gold and Silver

The gold and silver particles and flakes used in Example 15 were obtained from Aldrich. The gold particles had a particle size in the range 1.5 to 3.0 μm; the silver powder had a particle size in the range 2 to 3.5 nm; the silver flake had a particle size of <10 μm; and the nanosize silver had a particle size of about 100 nm but it tended to agglomerate to about 1 to 2 μm.

In the Examples, following clays were used as the organically-modified layered inorganic species.

### Clays

Organophilic modified montmorillonites available from Southern Clay Products, Inc. (Gonzales, Tex., USA), marketed under the trademark Cloisite® and their modifications, modifier concentration, and d₀₀₁ basal spacing as provided by the supplier are shown in Table 2. For comparison purposes, a hydrophilic non-modified sodium montmorillonite available from Southern Clay Products, Inc. and also marketed under the trademark Cloisite® was also used. The clays were received as a fine powder with an average particle size of 8 μm. The as received powdery clays were dried at 100° C. under vacuum for 2 days immediately prior to use.

In order of increasing hydrophobicity, the clays are 15A, 20A, 25A, 10A, 30B, NaMMT

TABLE 2

| | SCP | Organic | Modifier | |
|---|---|---|---|---|
| | designa- | alkylammonium | concentration^{c} | d₀₀₁ ^{d} |
| Clay | tion^{a} | ion^{b} | (meq/100 g clay) | (nm) |
| NaMMT | Cloisite ® | — | 92.6^{e} | 1.17 |
| | Na+ | | | (0.97) |
| 10A | Cloisite ® | Dimethyl benzyl | 125 | 1.92 |
| | 10A | T ammonium | | (1.85) |
| 15A | Cloisite ® | Dimethyl di(HT) | 125 | 3.15 |
| | 15A | ammonium | | (3.10) |
| 20A | Cloisite ® | Dimethyl di(HT) | 95 | 2.4 |
| | 20A | ammonium | | |
| 25A | Cloisite ® | Dimethyl 2- | 95 | 1.86 |
| | 25A | ethylhexyl | | |
| | | HT ammonium | | |
| 30B | Cloisite ® | Bis(2-hydroxy- | 90 | 1.85 |
| | 30B | ethyl)methyl | | (1.74) |
| | | T ammonium | | |

^{a}Commercial designations provided by Southern Clay Products, Inc.
^{b}T = tallow, HT = hydrogenated tallow. Tallow is a natural product composed predominantly of unsaturated C₁₈ (65%), C₁₆ (30%), and C₁₄ (5%) alkyl chains. The term HT denotes the tallow-based alkyl chains in which majority of the double bonds have been hydrogenated.
^{c}The amount of milliequivalents of ammonium salt used per 100 g of montmorillonite during the cationic exchange reaction with the pristine sodium montmorillonite.
^{d}The basal spacing corresponds to the characteristic Bragg reflection peak of d₀₀₁ obtained by XRD. The values in parenthesis were obtained from XRD measurements made by the Applicant.
^{e}Cation exchange capacity of the sodium montmorillonite.

### Solvents

The solvents listed in Table 3, Example 1, were all either technical-grade or high-purity grade, and were used as received.

### Epoxy System

The epoxy resin used in Example 8 was a diglycidyl ether of bisphenol A available as EPON™828 (Resolution Performance Products) with an epoxy equivalent weight of 184-190, a specific gravity of 1.16 g ml⁻¹ at 25° C., and a molecular weight of about 377 g mol-1. The curing agent used in was 4,4′-methylene bis(2,6-diethylaniline) purchased from Sigma-Aldrich Co. (Gillingham, Dorset, United Kingdom).

### Methacrylate Systems

The methacrylate monomers listed in Table 9, Example 10, were all purchased from Sigma-Aldrich Co. (Gillingham, Dorset, United Kingdom). The thermal curing initiator used was 1,1-di(tertbutylperoxy)-3,3,5-trimethyl cyclohexane (Trigonox 29-B90®, 90% solution in dibutyl phthalate) and was obtained from Akzo Nobel Polymer Chemicals BV.

### Preparation of Clay or Fine Particle and Liquid Organic Medium Dispersions

Samples of solvent-, epoxy-, and methacrylate-based clay or fine particle dispersions were made by adding a predetermined amount of clay or fine particles to a measured quantity of the liquid organic medium, which was hand-mixed for 1 min to crudely distribute the clay or fine particles through the liquid. The sample was then mixed for 2×5 min with a dual asymmetric centrifugal mixer (FlackTek SpeedMixer™ DAC 150 FVZ, Hauschild Engineering, Germany) operating at 3000 rpm using 20 wt % of ceramic beads (ytrria-stabilized zirconia beads (diameter: 2 mm) sold under the trade name Zirmil available from Saint-Gobain ZirPro (Zirconium Products), a department of Saint-Gobain Grains and Powders Division). The total weight of each sample was 20 g (excluding the ceramic beads).

### Preparation of Clay/Fine Particles/Liquid Organic Medium Dispersions

Clay/liquid organic medium samples were prepared as described above. A predetermined amount of fine particles was then added to each sample and hand-mixed into the sample. The sample was then mixed for another 2×5 min with the centrifugal mixer to disperse the fine particles. The total weight of each sample was 20 g (excluding the ceramic beads).

### Preparation of Cured Epoxy-Based Carbon Nanotubes/Organoclay Bulk Samples

Following removal of the ceramic beads from samples of the epoxy precursor dispersions in accordance with the method described above, the thermal curing agent was added with a molar ratio of 1 of epoxide monomer to 0.77 curing agent. The curing agent was dispersed into the mixture by an additional mixing for 2×5 min at 3000 rpm using the centrifugal mixer. The extra mixing of the epoxy-based samples was required owing to the solid nature of the epoxy curing agent (˜24 wt %) as compared to the methacrylate initiator (˜1 wt %) (see below). However, despite the high initial viscosity of the epoxy precursor, all mixtures remained highly fluid and were poured into stainless steel pans for curing. Thermal curing of the mixtures was conducted isothermally in an oven at 180° C. for 2 h.

### Preparation of Methacrylate-Based Carbon Nanotubes/Organoclay Films

Following removal of the ceramic beads from samples of methacrylate dispersions in accordance with the method described above, 1 wt % of the thermal curing initiator was added, followed by an additional mixing for 2 min at 3000 rpm using the centrifugal mixer. All mixtures continued to exhibit low viscosity and remained highly fluid. The samples were poured into stainless steel pans for curing. Thermal curing of the mixtures was conducted in three consecutive steps: 0.5 h at 120° C., 0.5 h at 140° C., and 1 h at 150° C.

### Measurement of Electrical Conductivity of Samples

1. Four probe conductivity measurements for films made from the samples with a conductivity down to 10⁻³ S cm¹:

The samples were sanded and polished and four electrodes comprising silver conductive paste were applied. The electrical conductivity of the samples Was measured by a four-probe conductivity measurement using a Keithley Instruments 610C solid-state electrometer connected to a Jandel universal probe.
2. Two probe conductivity measurements for films made from the samples with a conductivity in the range of 10⁻³ to 10⁻⁶ S cm⁻¹:

The samples were sanded and polished and two electrodes comprising silver conductive paste were applied. The electrical conductivity of the samples was measured by a two-probe conductivity measurement using a Philips Pm 2518 RMS multimeter.
3. Two probe conductivity measurements for cured samples with a conductivity in the range of 10⁻⁷ to 10⁻¹⁵ S cm⁻¹:

The samples were sanded and polished and two electrodes comprising silver conductive paste were applied. The electrical conductivity of the samples was measured by a two-probe conductivity measurement using a Keithley Instruments 610C solid-state electrometer.

The surface resistivity of the samples was calculated from the conductivity.

### Measurement of Transparency of Samples

Adhesive tape of 25 micron thickness or greater (tapes being overlaid to achieve desired thicknesses as required) was applied to each long side of standard glass microscope slides to define a channel therebetween on each slide. The uncured sample under test was dragged into the channel between the tapes using another glass microscope slide, thereby producing a film of 25 microns thickness or greater depending on the thickness of the tape defining the channel. The transmission was immediately recorded at 550 nm using a Varian Cary 1C UV-visible spectrophotometer and an Integrating Sphere (DRA-CA-301) from Labsphere.

### Example 1

Samples of clay/solvent were made up by the method described above. The solvents used are listed in Table 3 below. The samples contained 0.4 g of clay, ie 2 wt %, and 19.6 g of solvent. Following removal of the ceramic beads from the samples, an amount of each sample was put into a glass vial (the amount was sufficient to occupy about 80% to 90% of the volume of the vial). The vials containing the samples were permitted to stand undisturbed for 4 days (96 hours) following which the height of the sample in the vial was measured together with the height of any obvious sediment in the vial. Where there was no obvious settlement of the clay, the height of the sediment was taken to be equal to the height of the sample. The height of the settled volume, ie the sediment, was then expressed as a percentage of the total height of the sample. The results are shown in Table 3.

At least some of the vials were re-measured after 60 days and those results are given in brackets in Table 3.

A small aliquot of each sample was viewed under a Nikon Optiphot-Pol optical microscope. If the sample was found to be optically clear, even when using cross-polarized light, which could indicate that the organoclay is highly intercalated and/or exfoliated. The samples at around the 100% level and just below tended to exhibit such behaviour.

A 2 wt % of clay sample was a convenient amount to use as, if the clay was highly intercalated and/or exfoliated, the clay visually filled the available volume of dispersion in the vial, ie gave a 100% figure. In contrast, for smaller wt % s of clay there was insufficient clay present to fill the sample volume and they developed a visually clear portion of solvent above the sediment in the vial notwithstanding the clay was highly intercalated and/or exfoliated, ie there was insufficient clay present to fill the sample volume. Additionally, the set of vials containing the samples for toluene (following 4 days settlement) are shown in FIG. 1.

The percentage figure is indicative of the amount of dispersion and intercalation and/or exfoliation of the clays in the solvents. It is to be noted that, whilst the clay increased the viscosity of the dispersion marginally in most instances compared to the solvent alone, the dispersions all had a low viscosity and were highly fluid. Only the dispersions of the 10A organoclay and toluene, chloroform and o-xylene solvents showed any significant degree of gelling but even those organoclay/solvent dispersions were still pourable. The addition of carbon nanotubes to such dispersions made no appreciable difference to the viscosities of the dispersions.

This is in contrast to the highly viscous gel network obtained by J A Johnson et al as described in the article referred to above. As described in the article, the dispersed carbon nanotubes, clay and solvent formed viscous gel networks that had to be broken down by the addition of a suitable dispersant/surfactant, to convert it into a low viscosity fluid.

TABLE 3

| | | | Clay | | | | |
|---|---|---|---|---|---|---|---|
| Solvent | A* | NaMMT | 30B | 10A | 25A | 20A | 15A |
| Iso-hexane | 14.1 | 15 (15)% | 18 (16)% | 41 (38)% | 31 (26)% | 63 (55)% | 64 (59)% |
| Toluene | 18.2 | 22 (15)% | 57 (42)% | 100 (97)% | 86 (62)% | 82 (78)% | 100 (97)% |
| o-Xylene | | 14% | 54% | 100% | 83% | 100% | 100% |
| Chloroform | 19.0 | 26 (24)% | 58 (57)% | 100 (100)% | 100 (95)% | 95 (89)% | 100 (100)% |
| Tetrahydrofuran | 19.4 | 15 (15)% | 79 (74)% | 100 (82)% | 82 (80)% | 95 (84)% | 100 (87)% |
| Anisole | | 21% | 67% | 100% | 71% | 57% | 53% |
| Methyl benzoate | | 26% | 65% | 100% | 77% | 77% | 67% |
| Acetone | 20.0 | 26(26)% | 71 (66)% | 66 (61)% | 71 (66)% | 62 (47)% | 53 (51)% |
| Methyl ethyl ketone | | 28% | 79% | 73% | 93% | 55% | 34% |
| 2-Butoxyethyl acetate | 20.0 | 27 (20)% | 53% | 67 (63)% | 63 (59)% | 50% | 37 (31)% |
| N-methyl-2-pyrrolidone | 22.9 | 10 (10)% | 100% (100) | 90 (54)% | 67 (49)% | 41 (34)% | 43 (35)% |
| 2-Ethoxyethyl acetate | | 28% | 48% | 62% | 52% | 47% | 36% |
| 4-Methyl 1-cyclohexane | | | | 54% | | | |
| Methyl cyclohexane | | | | 45% | | | |
| Ethanol | 26.5 | 38 (38)% | 28 (28)% | 28 (26)% | 36 (33)% | 33 (30)% | 31 (10)% |

*Column A is the Hansen solubility parameter and values are given in MPa^{1/2}. The values quoted are from literature sources.

### Example 2

Samples Sol-1 (1 wt % CNT-A), Sol-2 (1 wt % CNT-A+0.1 wt % organoclay 10A) and Sol-3 (1.0 wt % CNT-A+1.0 wt % organoclay 10A) were made up as described above in toluene. Aliquots of 19 and 2 g, respectively, were added to stainless steel dishes and the toluene was evaporated off under vacuum and at a temperature of 40° C. Photographs of the dishes containing the samples are shown in FIG. 2. The upper row is the dishes that contained 1 g of dispersion prior to evaporation of the solvent and the lower row is the dishes that contained 2 g of dispersion prior to evaporation of the solvent. As can be seen, it is clear that the amount of sample added to the dish has an affect on the appearance of the dried film of the carbon nanotubes. However, it is quite apparent that Sol-1 (no organoclay present) exhibits significant “mud cracking”, ie similar to cracks that appear in mud when it dries out, at both levels of sample in the dishes. Sol-2 and Sol-3 show significant improvements over Sol-1 and, in particular, Sol-2 at the 2 g level and Sol-3 at both the 19 and the 2 g levels show coherent films of carbon nanotubes.

### Example 3

Samples of dispersions were made up in toluene as shown in Table 4. The total weight of carbon nanotubes and/or organoclay in each sample was 1 wt %, the balance being toluene. For example, the 50:50 sample had 0.5 wt % carbon nanotubes and 0.5 wt % organoclay and 99 wt % toluene. Aliquots of the samples were placed on a PET film (ex-Du Pont Teijin, Melinex 506, 210x297 mm, 175 μm thick) and spread to form a film using a 1 mil (25 μm) drawbar to form a thin layer of dispersion. The toluene was evaporated off in a fume cupboard overnight under ambient conditions. The conductivity of the resultant carbon nanotube/organoclay films was measured and the results are shown in Table 4. Photographs of Films 1, 2 and 4 are shown in FIGS. 3 and 4. As shown in FIG. 4, the films had been subjected to scratching with tweezers. As can be seen from Films 2 and 4, the organoclay, in addition to enabling better, and thinner film formation, imparts a significant level of scratch resistance to the film. It was also observed the films containing the organoclay were substantially homogeneous and significantly less powdery. Film 4 was broken and the edge of it was examined under a scanning electron microscope. The SEM micrograph (see FIG. 5) showed the carbon nanotubes appeared to have some degree of orientation within the film, the nanotubes being oriented between layers of clay platelets.

TABLE 4

| | | | Surface | |
|---|---|---|---|---|
| | Materials | Conductivity | Resistivity | Thickness |
| Film | CNT-A/10A | (S cm⁻¹) | (Ω/) | (μm) |
| 1 | 100/0 | 478 | 0.523 | 40 |
| 2 | 90/10 | 100 | 14.0 | 7 |
| 3 | 70/30 | 42 | 27 | 9 |
| 4 | 50/50 | 11 | 457 | 2 |
| 5 | 30/70 | 7 | 206 | 7 |
| 6 | 10/90 | Not conductive | Not conductive | |
| 7 | 0/100 | Not conductive | Not conductive | |

### Example 4

Example 3 was repeated for Films 2 and 4 but with 0.20 wt % polystyrene (ex-Aldrich) replacing 0.20 wt % toluene (Films 2A and 4A) to give a final film polymer content of 20 wt %. The conductivity of the resultant carbon nanotube/organoclay/polystyrene films was measured and the results are shown in Table 5, the results of Films 2 and 4 being included for comparison between the films without and with polymeric binder.

TABLE 5

| | | | Surface | |
|---|---|---|---|---|
| | Materials | Conductivity | Resistivity | Thickness |
| Film | CNT-A/10A | (S cm⁻¹) | (Ω/) | (μm) |
| 2 | 90/10 | 100 | 14.0 | 7 |
| 2A | 90/10 | 74 | 9.7 | 14 |
| 4 | 50/50 | 11 | 457 | 2 |
| 4A | 50/50 | 17 | 103 | 6 |

### Example 5

Example 3 was repeated for the ratios shown in Table 6 but using carbon nanotubes CNT-C, CNT-D and carbon black (“CB”) (ex-Degussa). The conductivity of the resultant carbon nanotube/organoclay films was measured and the results are shown in Table 6.

TABLE 6

| | | | | Surface | |
|---|---|---|---|---|---|
| | | | Conductivity | Resistivity | Thickness |
| Film | Ratio | Materials | (S cm⁻¹) | (Ω/) | (μm) |
| 8 | 100/0 | CNT-B | 120 | 9 | 12 |
| 9 | 100/0 | CNT-D | 75 | 15 | 9 |
| 10 | 100/0 | CB | 25 | 255 | 9 |
| 11 | 90/10 | CNT-B | 95 | 4 | 5 |
| 12 | 90/10 | CNT-D | 43 | 12 | 20 |
| 13 | 90/10 | CB | 11 | 307 | 3 |
| 14 | 50/50 | CNT-B | 11 | 126 | 7 |
| 15 | 50/50 | CNT-D | 12 | 107 | 2 |
| 16 | 50/50 | CB | 1.5 | 4950 | 3 |

### Example 6

Example 3 was repeated but with the total weight of carbon nanotubes and/or organoclay in the sample was 3 wt %, the balance being toluene. The CNT-A/10A was 50:50. A plastic probe was dipped into the resultant dispersion and upon removal the toluene was evaporated off in a fume cupboard overnight under ambient conditions leaving a thin coating on the end of the probe (see FIG. 6).

### Example 7

Example 3 was repeated but using ITO both without and with organoclay 10A as shown in Table 7. Without the organoclay, the ITO was poorly dispersed in the toluene and quickly settled out. With the organoclay, the ITO was well dispersed in the toluene and the dispersion exhibited stability.

TABLE 7

| Sample | Wt % ITO | Wt % 10A |
|---|---|---|
| ITO-1 | 0.2 | |
| ITO-2 | 2.0 | |
| ITO-3 | 0.2 | 1.8 |
| ITO-4 | 1.0 | 1.0 |
| ITO-5 | 1.8 | 0.2 |

### Example 8

Samples of epoxy precursor dispersions were made up by the method described above and as detailed in Table 7. In all instances, the viscosity of the epoxy precursor was sufficiently high to prevent visible sedimentation of the clays and/or the CNT in the dispersions.

A few drops of each sample was trapped between glass microscope slides and examined under a Nikon Optiphot-Pol optical microscope under both normal and cross-polarised light. The samples were examined as mixed and after periods of time. Some samples were also cured as described above. Photographs of some of the microscopy results are shown in FIGS. 7 to 14.

Samples Epoxy-1 to Epoxy-4 (see FIG. 7) exhibited different levels of intercalation/exfoliation of the clays. As can be seen by the visible clay stacks/aggregates and the level of crystallinity shown in the micrograph taken using polarised light, Sample Epoxy-1, ie the unmodified clay, remained substantially crystalline and no significant intercalation had occurred. In contrast, the Samples Epoxy-2 to Epoxy-4 showed varying levels of intercalation/exfoliation, the order of the degree of intercalation/exfoliation being Epoxy-3<Epoxy-4<Epoxy-2. The intercalation/exfoliation of these samples was also checked using X-ray diffraction.

In Samples Epoxy-5 to Epoxy-8, which contained carbon nanotubes, the same trend is observed with the carbon nanotubes being dispersed throughout the samples (see FIG. 8).

TABLE 7

| Sample No | Clay Type | Wt % of Clay | CNT Type | Wt % of CNT |
|---|---|---|---|---|
| Epoxy-1 | NaMMT | 5 | — | — |
| Epoxy-2 | 10A | 5 | — | — |
| Epoxy-3 | 15A | 5 | — | — |
| Epoxy-4 | 30B | 5 | — | — |
| Epoxy-5 | NaMMT | 5 | CNT-A | 0.1 |
| Epoxy-6 | 10A | 5 | CNT-A | 0.1 |
| Epoxy-7 | 15A | 5 | CNT-A | 0.1 |
| Epoxy-8 | 30B | 5 | CNT-A | 0.1 |
| Epoxy-9 | — | — | CNT-A | 0.1 |
| Epoxy-10 | — | — | CNT-A | 1.0 |
| Epoxy-11 | NaMMT | 0.1 | CNT-A | 1.0 |
| Epoxy-12 | 10A | 0.1 | CNT-A | 1.0 |
| Epoxy-13 | 15A | 0.1 | CNT-A | 1.0 |
| Epoxy-14 | 10A | 0.1 | CNT-D | 0.5 |
| Epoxy-15 | — | — | CNT-B | 0.5 |
| Epoxy-16 | 10A | 0.1 | CNT-B | 0.5 |
| Epoxy-17 | 10A | 0.1 | CNT-C | 0.5 |

The Samples Epoxy-6 and Epoxy-7 were allowed to stand for 60 min and were re-examined. Both Samples Epoxy-6 and Epoxy-7 (see FIG. 9) remained well dispersed and showed no sign of re-aggregation of the carbon nanotubes even though, in the case of Sample Epoxy-7, owing to the significantly lower level of intercalation of the clay it may be expected that some re-aggregation of the carbon nanotubes may occur.

In contrast, Samples Epoxy-9 and Epoxy-10 (see FIGS. 10 and 11, respectively) demonstrate that the carbon nanotubes in the epoxy precursor but absent the organoclay component clearly re-aggregate over time.

It will be appreciated the levels of clay in these samples are relatively high at 5 wt % and, for many applications that require conductivity to be present and good optical visibility, that level of clay will be precluded.

However, for intercalated/exfoliated organoclays, the Applicant has found that very small amounts of organoclay can significantly affect carbon nanotube re-aggregation. Thus, Sample Epoxy-12 (see FIG. 13), in which the organoclay to the carbon nanotubes weight-ratio is 1 to 10, no perceptible re-aggregation of the carbon nanotubes is to be seen over the time period. In contrast, when small amounts of unmodified clay are used, Sample Epoxy-11 (see FIG. 12), re-aggregation of the carbon nanotubes occurred.

Re-aggregation of the carbon nanotubes occurs in the absence of clay even when curing of the epoxy precursor dispersion is initiated immediately following mixing of the components to form the dispersion. This was demonstrated by curing portions of Samples Epoxy-10 and Epoxy-12 as previously described. Reference to FIG. 14 clearly shows that re-aggregation of the carbon nanotubes has occurred in Sample Epoxy-10 during curing, whereas the carbon nanotubes remained dispersed in the cured sample of Sample Epoxy-12. The cured films were of the order of 100-200 μm thick.

Sample Epoxy-13 performed similarly to Sample Epoxy-12.

Samples Epoxy-14 and Epoxy-17 in both dispersions and cured forms showed re-aggregation of the carbon nanotubes over the time period.

In Samples Epoxy-15 and Epoxy-16 in both dispersions and cured forms the carbon nanotubes remained dispersed.

### Example 9

Samples of the epoxy-based dispersions were made up and portions thereof were cured by the methods described above and as detailed in Table 8.

TABLE 8

| | | | | | | Transparency % |
|---|---|---|---|---|---|---|
| Sample | Clay | Wt % of | CNT | Wt % of | Conductivity | 35 μm film |
| No | Type | Clay | Type | CNT | S cm⁻¹ | (80 μm film) |
| Epoxy-18 | — | — | CNT-A | 1.0 | 2.5 × 10⁻⁴ | 18.1 (6.2) |
| Epoxy-19 | — | — | CNT-A | 0.5 | 3.3 × 10⁻⁶ | 41.9 (20.3) |
| Epoxy-20 | — | — | CNT-A | 0.3 | 3.2 × 10⁻⁹ | 55.2 (29.3) |
| Epoxy-21 | — | — | CNT-A | 0.2 | 5.3 × 10⁻¹¹ | 63.0 (53.9) |
| Epoxy-22 | — | — | CNT-A | 0.1 | 1.3 × 10⁻¹² | 73.8 (56.1) |
| Epoxy-23 | 10A | 5 | CNT-A | 1.0 | 1.0 × 10⁻¹¹ | — |
| Epoxy-24 | 10A | 5 | CNT-A | 0.5 | 1.6 × 10⁻¹² | — |
| Epoxy-25 | 10A | 5 | CNT-A | 0.3 | 2.0 × 10⁻¹² | — |
| Epoxy-26 | 10A | 5 | CNT-A | 0.2 | 2.4 × 10⁻¹² | — |
| Epoxy-27 | 10A | 5 | CNT-A | 0.1 | 3.4 × 10⁻¹² | — |
| Epoxy-28 | 10A | 5 | CNT-A | 1.0 | 1.0 × 10⁻¹¹ | — |
| Epoxy-29 | 10A | 2 | CNT-A | 1.0 | 2.0 × 10⁻⁹ | — |
| Epoxy-30 | 10A | 1 | CNT-A | 1.0 | 3.9 × 10⁻⁴ | — |
| Epoxy-31 | 10A | 0.5 | CNT-A | 1.0 | 2.4 × 10⁻⁴ | — |
| Epoxy-32 | 10A | 0.1 | CNT-A | 1.0 | 4.9 × 10⁻⁴ | — |
| Epoxy-33 | 10A | 0.5 | CNT-A | 1.0 | 2.4 × 10⁻⁴ | — |
| Epoxy-34 | 10A | 0.5 | CNT-A | 0.5 | 2.7 × 10⁻¹¹ | — |
| Epoxy-35 | 10A | 0.5 | CNT-A | 0.3 | 2.9 × 10⁻¹² | — |
| Epoxy-36 | 10A | 0.5 | CNT-A | 0.2 | 2.5 × 10⁻¹¹ | — |
| Epoxy-37 | 10A | 0.5 | CNT-A | 0.1 | 5.0 × 10⁻¹² | — |
| Epoxy-38 | 10A | 0.1 | CNT-A | 1.0 | 4.9 × 10⁻⁴ | 21.1 (8.8) |
| Epoxy-39 | 10A | 0.1 | CNT-A | 0.5 | 6.0 × 10⁻⁵ | 46.0 (25.8) |
| Epoxy-40 | 10A | 0.1 | CNT-A | 0.3 | 1.5 × 10⁻⁶ | 56.7 (34.7) |
| Epoxy-41 | 10A | 0.1 | CNT-A | 0.2 | 2.6 × 10⁻¹² | 65.9 (58.0) |
| Epoxy-42 | 10A | 0.1 | CNT-A | 0.1 | 3.8 × 10⁻¹³ | 76.0 (63.4) |
| Epoxy-43 | — | — | CNT-B | 1.0 | 1.5 × 10⁻³ | 14.2 (5.8) |
| Epoxy-44 | — | — | CNT-B | 0.5 | 1.5 × 10⁻⁴ | 27.0 (20.8) |
| Epoxy-45 | — | — | CNT-B | 0.3 | 1.4 × 10⁻⁴ | 47.5 (39.3) |
| Epoxy-45A* | — | — | CNT-B | 0.3 | 1.4 × 10⁻⁴ | (55.5) |
| Epoxy-46 | — | — | CNT-B | 0.2 | 1.9 × 10⁻⁵ | 65.8 (55.3) |
| Epoxy-47 | — | — | CNT-B | 0.1 | 3.5 × 10⁻¹² | 80.1 (73.6) |
| Epoxy-48 | 10A | 0.1 | CNT-B | 1.0 | 2.0 × 10⁻³ | 19.0 (6.3) |
| Epoxy-49 | 10A | 0.1 | CNT-B | 0.5 | 6.1 × 10⁻⁴ | 34.7 (27.8) |
| Epoxy-50 | 10A | 0.1 | CNT-B | 0.3 | 3.0 × 10⁻⁴ | 55.4 (52.8) |
| Epoxy-50A* | 10A | 0.1 | CNT-B | 0.3 | 3.0 × 10⁻⁴ | (64.7) |
| Epoxy-51 | 10A | 0.1 | CNT-B | 0.2 | 6.5 × 10⁻⁵ | 68.0 (59.1) |
| Epoxy-52 | 10A | 0.1 | CNT-B | 0.1 | 1.7 × 10⁻¹² | 85.8 (80.4) |
| Epoxy-53 | — | — | — | — | — | 99.6 (99.3) |
| Epoxy-54 | 10A | 0.1 | — | — | — | 99.2 (99.0) |

*To demonstrate the effect of the dilution of the sample by the curing agent has on the optical transparency, the curing agent was included in these two samples.

Referring to Table 8, the cured epoxy resins containing only carbon nanotubes CNT-A have a percolation threshold at about 0.5 wt % of carbon nanotubes (Samples Epoxy-18 to Epoxy-22), whereas with 5 wt % of organoclay 10A, the cured resins are essentially non-conductive (Samples Epoxy-23 to Epoxy-27). A reduction in organoclay level (Samples Epoxy-28 to Epoxy-32) shows that the percolation threshold is re-established for samples containing up to about 1 wt % of organoclay 10A. At 0.5 wt % of organoclay 10A, more than 0.5 wt % of carbon nanotubes CNT-A is required to establish a percolation threshold (Samples Epoxy-33 to Epoxy-37). The cured epoxy resins containing only very small amounts of clay demonstrate a lowered percolation threshold as compared to the cured epoxy resins containing only the carbon nanotubes. Furthermore, the precursor dispersions containing only very small amounts of organoclay 10A show an improved transparency as compared to the epoxy precursor dispersions containing only the carbon nanotubes (Samples Epoxy-38 to Epoxy-42 and Samples Epoxy-18 to Epoxy-22, respectively) or higher amounts of clay.

Cured samples of the epoxy precursor dispersions containing carbon nanotubes CNT-B similarly demonstrate a slightly lowered percolation threshold as compared to the cured epoxy resins containing only the carbon nanotubes. Furthermore, the precursor dispersions containing only very small amounts of organoclay 10A show an improved transparency as compared to the epoxy precursor dispersions containing only the carbon nanotubes (Samples Epoxy-48 to Epoxy-52 and Samples Epoxy-43 to Epoxy-47, respectively).

The transparencies quoted will be improved even further when, as demonstrated by Samples Epoxy-45/Epoxy-45A and Epoxy-50/Epoxy-50A, the curing agent dilutes the dispersions.

Samples Epoxy-53 and Epoxy-54 are provided for comparison.

Thus, it will be appreciated that dispersions in accordance with the invention lead to a reduction in the percolation threshold in combination with improved transparency, especially when the dilution affect of the addition of the curing agent is taken into effect.

### Example 10

Samples of methacrylate dispersions were made up by the method described above. The methacrylates used are listed in Table 9 below. The samples contained 0.49 of clay, ie 2 wt %, and 19.6 g of methacrylate monomer. Following removal of the ceramic beads from the samples, an amount of each sample was put into a glass vial (the amount was sufficient to occupy about 80% to 90% of the volume of the vial). The vials containing the samples were permitted to stand undisturbed for 4 days (96 hours) following which the height of the sample in the vial was measured together with the height of any obvious sediment in the vial. Where there was no obvious settlement of the clay, the height of the sediment was taken to be equal to the height of the sample. The height of the settled volume, ie the sediment, was then expressed as a percentage of the total height of the sample. The results are shown in Table 9. Additionally, the set of vials containing the samples for isobornyl methacrylate are shown in FIG. 15. Some samples contained both sediment and a floating portion; the percentage of the combination of the heights of the sediment and the floating portion is quoted in brackets in Table 9.

A small aliquot of each sample was viewed under a Nikon Optiphot-Pol optical microscope. If the sample was found to be optically clear, even when using cross-polarized light, that was indicative that the clay is highly intercalated and/or exfoliated. The samples at around the 100% level and just below tended to exhibit such behaviour.

TABLE 9

| | | | Clay | | | | |
|---|---|---|---|---|---|---|---|
| Solvent | A* | NaMMT | 30B | 10A | 25A | 20A | 15A |
| Stearyl methacrylate | 16.0 | 20% | 23% | 43% | 41% | 45% | 34 |
| | | | | | | | (86)% |
| Isobornyl methacrylate | 16.6 | 23% | 35% | 61% | 45% | 61% | 87% |
| Lauryl methacrylate | 16.8 | 23% | 27% | 33% | 34% | 62% | 43 |
| | | | | | | | (73)% |
| Isodecyl methacrylate | | 23% | 27% | 17 | 27% | 20 | 33 |
| | | | | (83)% | | (83)% | (90)% |
| t-Butyl methacrylate | 18.0 | 21% | 47% | 34% | 71% | 60% | 69% |
| Ethyl methacrylate | 18.4 | 17% | 79% | 100% | 83% | 59% | 52% |
| Methyl methacrylate | 19.4 | 20% | 47% | 87% | 86% | 41% | 37% |
| 2-Hydroxyethyl | 27.4 | 17% | 17% | 33% | 23% | 30% | 27% |
| methacrylate | | | | | | | |

*Column A is the Hansen solubility parameter and values are given in MPa^{1/2}. The values quoted are from literature sources.

### Example 11

Samples were made up using isobornyl methacrylate (iBMA) and ethyl methacrylate (EMA) as shown in Table 10.

TABLE 10

| Sample | | Clay | Wt % of | CNT | Wt % of |
|---|---|---|---|---|---|
| No | Methacrylate | Type | Clay | Type | CNT |
| Meth-1 | iBMA | — | — | CNT-A | 0.1 |
| Meth-2 | iBMA | — | — | CNT-A | 0.3 |
| Meth-3 | iBMA | — | — | CNT-A | 0.5 |
| Meth-4 | iBMA | — | — | CNT-A | 1.0 |
| Meth-5 | iBMA | 15A | 0.1 | CNT-A | 0.1 |
| Meth-6 | iBMA | 15A | 1.0 | CNT-A | 0.1 |
| Meth-7 | iBMA | 15A | 0.1 | CNT-A | 0.3 |
| Meth-8 | iBMA | 15A | 0.1 | CNT-A | 0.5 |
| Meth-9 | iBMA | 15A | 0.1 | CNT-A | 1.0 |
| Meth-10 | iBMA | 10A | 1.0 | CNT-A | 0.1 |
| Meth-11 | EMA | — | — | CNT-A | 1.0 |
| Meth-12 | EMA | — | — | CNT-A | 0.3 |
| Meth-13 | EMA | — | — | CNT-A | 0.5 |
| Meth-14 | EMA | — | — | CNT-A | 1.0 |
| Meth-15 | EMA | 10A | 0.1 | CNT-A | 1.0 |
| Meth-16 | EMA | 10A | 0.1 | CNT-A | 0.3 |
| Meth-17 | EMA | 10A | 0.1 | CNT-A | 0.5 |
| Meth-18 | EMA | 10A | 0.1 | CNT-A | 1.0 |

The Samples Meth-1 to Meth-4 and Meth-11 to Meth-14 without any organcclay showed very poor dispersion of the carbon nanotubes but no additional re-aggregation of the carbon nanotubes appeared to occur. The dispersability of the carbon nanotubes was improved by the addition of the organoclay, the improvement being proportional to the level of organoclay added (Samples Meth-5 to Meth-10 and Meth-15 to Meth-18).

The addition of 5 wt % of poly-iBMA to Sample Meth-1 did not improve the dispersibility of the carbon nanotubes and at 10 wt % poly-iBMA additionally caused re-aggregation of the carbon nanotubes to occur.

### Example 12

Samples were made up using solvents and carbon black as shown in Table 11.

TABLE 11

| | | Clay | Wt % of | |
|---|---|---|---|---|
| Sample No | Solvent | Type | Clay | Wt % of CB |
| CB-1 | Methyl ethyl ketone | — | — | 0.2 |
| CB-2 | Methyl ethyl ketone | 25A | 2 | 0.2 |
| CB-3 | o-xylene | — | — | 0.2 |
| CB-4 | o-xylene | 10A | 2 | 0.2 |

As can be seen from FIGS. 16 and 17 (in which the micrographs were taken immediately after mixing), without the organoclay (Samples CB-1 and CB-3), the carbon black was poorly dispersed in the solvent and rapidly settled out whereas, in the presence of the organoclay (Samples CB-2 and CB-4), the carbon black was well dispersed and the dispersions exhibited stability for at least one week.

Such dispersions in accordance with the invention, especially when incorporating a reactive precursor of a polymeric binder, for example an epoxy resin precursor and curing agent, may find utility in thermal ink jet printer applications. In such applications, typically the viscosity of the ink has to be not more than 20 cP and the particle size has to be not more than 5 μm. Using solvent/reactive precursor solutions, the carbon black does not disperse well and settles out almost immediately. Even when anti-settling agents are added, although the rate of settling is decreased, the settling of the carbon black is not eliminated over the useful life of such dispersions, eg minimum 8 hour shift, preferably 24 hour period.

Clearly, dispersions in accordance with the invention overcome such problems.

### Example 13

Samples were made up using 0.2 wt % fullerite, using methyl ethyl ketone and toluene as the solvents both without clay and with 2.0 wt % of clay 10A. In both cases, the dispersions of the fullerite samples were improved by the addition of the organoclay.

When the methyl ethyl ketone was used as the solvent, examination of the vials after one week showed that, without the organoclay, the dispersion was cloudy with sedimentation oh the bottom of the vial and that, with the organoclay, although the dispersion had settled slightly, ie it occupied 87% of the total volume of liquid, it was uniform in colour with no apparent sedimentation.

Toluene is a known solvent for fullerenes. Consequently, both samples appeared to be clear, dark red solutions, even after one week. However, examination of the solutions after mixing showed that the sample without the organoclay clearly had a significant proportion of non-dispersed fullerite agglomerations as compared to the sample with the organoclay—see FIG. 18.

### Example 14

Samples were made up using 0.2 wt % conductive polyaniline particles, using toluene as the solvent both without clay and with 2.0 wt % of clay 10A. Without the organoclay, the polyaniline was poorly dispersed in the solvent and rapidly settled out whereas, in the presence of the organoclay, the polyaniline was well dispersed and the dispersion exhibited stability for at least one week—see FIG. 19 (taken at one week).

### Example 15

Samples were made up using gold and silver particles (Au and Ag respectively in Table 10) with toluene as the solvent and both without clay and with organoclay 10A as shown in Table 10.

TABLE 10

| | | | Amount of |
|---|---|---|---|
| | | Amount of Au | organo-clay |
| Sample | Particle size | or Ag (wt %) | (wt %) |
| Au-1 | Powder 1.5 to 3 μm | 1.0 | — |
| Au-2 | Powder 1.5 to 3 μm | 1.0 | 2.0 |
| Ag-1 | Nanosize activated powder | 0.2 | — |
| Ag-2 | Nanosize activated powder | 0.2 | 2.0 |
| Ag-3 | Powder 2 to 3.5 μm | 0.2 | — |
| Ag-4 | Powder 2 to 3.5 μm | 0.2 | 2.0 |
| Ag-5 | Flake <10 μm | 0.2 | — |
| Ag-6 | Flake <10 μm | 0.2 | 2.0 |

Without the clay, in all instances the Samples Au-1, Ag-1, Ag-3 and Ag-5 showed significant agglomeration and poor dispersion of the particles when examined under a microscope following mixing. This was particularly evident in Sample Au-1. In these Samples, the particles settled rapidly.

In contrast, in the presence of the organoclay, Samples Au-2, Ag-2, Ag-4 and Ag-6 were all well dispersed when examined under a microscope following mixing. The Samples remained stable dispersions for at least 4 days following mixing.

From the Examples, it appears that suitable liquid organic media for use in the invention have a total Hansen solubility parameter in the range 14 to 24, more preferably in the range 16 to 23 and more especially in the range 16 to 23.

1. A non-aqueous dispersion comprising an organic solvent comprising at least 50 wt % of said dispersion and a solids component which comprises not more than 20 wt % of said dispersion, said solids component comprising fine particles and an organically-modified layered inorganic species capable of being dispersed by said solvent and, optionally, an organic polymeric species and/or a reactive precursor of an organic polymeric species soluble in said solvent, said polymeric species and/or reactive precursor of a polymeric species when present comprising less than 50 wt % of said solids content.

2. A dispersion according to claim 1 wherein the solvent comprises at least 70 wt % of said dispersion.

3. A dispersion according to claim 1 wherein the solids component comprises not more than 15 wt % of said dispersion and more especially not more than 10 wt % of said dispersion.

4. A dispersion according to claim 1 wherein the solids component comprises not more than 5 wt % of said dispersion.

5. A dispersion according to claim 1 wherein the solids component comprises at least 0.1 wt %, more preferably at least 0.5 wt % of said dispersion.

6. A dispersion according to claim 1 wherein said polymeric species and/or reactive precursor of a polymeric species when present comprises less than 35 wt % of said solids content and more especially less than 25 wt % of said solids content.

7. A dispersion according to claim 1 wherein the polymeric species and/or a reactive precursor of a polymeric species when present comprises at least 1 wt % of said solids content, more preferably at least 5 wt % of said solids content, and especially at least 10 wt % of said solids content.

8. A dispersion according to claim 1 wherein the weight ratio of fine particles to said species is in the range 99:1 to 1:99.

9. A dispersion according to claim 8 wherein the weight ratio of fine particles to said species is not more than 90:10 and more especially is not more than 70:30.

10. A dispersion according to claim 8 wherein the weight ratio of fine particles to said species is not less than 10:90, and more especially is not less than 20:80.

11. A dispersion according to claim 1 wherein the fine particles are selected from metal and metal oxide particles, carbon particles, conductive polymeric particles; functional and non-functional fillers and additives, colourants, pigments, curing agents, catalysts and encapsulant systems.

12. A dispersion according to claim 1 wherein the fine particles are selected from electrically-conductive particles.

13. A dispersion according to claim 1 wherein the fine particles are selected from metal and metal oxide particles and/or carbon particles.

14. A dispersion according to claim 1 wherein the fine particles are carbon particles.

15. A dispersion according to claim 1 wherein the fine particles are carbon nanotubes or carbon black.

16. A dispersion according to claim 1 wherein the organically-modified layered inorganic species comprises an organoclay or an organically-modified layered double hydroxide.

17. A dispersion according to claim 1 wherein the organically-modified layered inorganic species is a natural or synthetic organoclay.

18. A dispersion according to claim 1 wherein the organically-modified layered inorganic species comprises a synthetic and naturally occurring layered double hydroxide in which organic anions have been substituted for inorganic anions within the interlayer regions thereof.

19. A dispersion according to claim 1 wherein the organically-modified layered inorganic species and the solvent combinations are selected to have a settled volume of at least 50% or higher, said settled volume being determined as hereinbefore described.

20. A dispersion according to claim 1 wherein the solvent is selected from organic solvents in the group comprising aliphatic, including cyclic aliphatic, and aromatic hydrocarbons, including substituted hydrocarbons, alcohols, ethers, including cyclic, aromatic and aromatic-aliphatic ethers, aliphatic, cyclic aliphatic, aromatic or heterocyclic carbonyl compounds (more particularly ketones), aliphatic and aromatic esters and alkoxyesters (particularly C₁ to C₆ alkoxyesters) and mixtures thereof.

21. A dispersion according to claim 20 wherein the solvent is selected from aliphatic and aromatic hydrocarbons, including halogen-substituted hydrocarbons, ethers, including cyclic, aromatic and aromatic-aliphatic ethers, aliphatic or heterocyclic ketones, aliphatic and aromatic esters and alkoxyesters (particularly Ci to C₆ alkoxyesters) and mixtures thereof.

22. A dispersion according to claim 20 wherein the solvent is selected from the group consisting of iso-hexane, toluene, xylene, chloroform, acetone, methyl ethyl ketone, N-methyl-2-pyrrolidone, tetrahydrofuran, anisole, methyl benzoate, 2-butoxyethylacetate, 2-ethoxyethylacetate and mixtures thereof.

23. A dispersion according to claim 1 wherein said polymeric species and/or reactive precursor of a polymeric species comprises a polymeric species derived from thermosetting polymers, thermoplastic polymers, elastomers and mixtures thereof, the reactive precursors being selected from precursors for addition-polymerisation resins, epoxide resins, cyanate ester resins, isocyanate resins (polyurethanes) or formaldehyde condensate resins or mixtures thereof.

24. A non-aqueous dispersion comprising a liquid reactive precursor of an organic polymeric species comprising at least 50 wt % of said dispersion and a solids component which comprises not more than 20 wt % of said dispersion, said solids component comprising fine particles and an organically-modified layered inorganic species capable of being dispersed by said reactive precursor.

25. A dispersion according to claim 24 wherein the solids component comprises not more than 15 wt % of said dispersion and more especially not more than 10 wt % of said dispersion.

26. A dispersion according to claim 24 wherein the solids component comprises not more than 5 wt % of said dispersion.

27. A dispersion according to claim 24 wherein the solids component comprises at least 0.1 wt %, more preferably at least 0.5 wt % of said dispersion.

28. A dispersion according to claim 24 wherein the weight ratio of fine particles to said species is in the range 99:1 to 1:99.

29. A dispersion according to claim 28 wherein the weight ratio of fine particles to said species is not more than 90:10 and more especially is not more than 70:30.

30. A dispersion according to claim 28 wherein the weight ratio of fine particles to said species is not less than 10:90, and more especially is not less than 20:80.

31. A dispersion according to according to claim 24 wherein the fine particles are selected from metal and metal oxide particles, carbon particles, conductive polymeric particles; functional and non-functional fillers and additives, colourants, pigments, curing agents, catalysts and encapsulant systems.

32. A dispersion according to claim 24 wherein the fine particles are selected from electrically-conductive particles.

33. A dispersion according to according to claim 24 wherein the fine particles are selected from metal and metal oxide particles and/or carbon particles.

34. A dispersion according to claim 24 wherein the fine particles are carbon particles.

35. A dispersion according to claim 24 wherein the fine particles are carbon nanotubes or carbon black.

36. A dispersion according to claim 24 wherein the organically-modified layered inorganic species comprises an organoclay or an organically-modified layered double hydroxide.

37. A dispersion according to claim 24 wherein the organically-modified layered inorganic species is a natural or synthetic organoclay.

38. A dispersion according to claim 24 wherein the organically-modified layered inorganic species comprises a synthetic and naturally occurring layered double hydroxide in which organic anions have been substituted for inorganic anions within the interlayer regions thereof.

39. A dispersion according to claim 24 wherein the organically-modified layered inorganic species and the precursor combinations are selected such that the inorganic species is intercalated and/or exfoliated by the precursor as assessed using optical microscopy and/or settling volume as hereinbefore described.

40. A dispersion according to claim 24 wherein said reactive precursor is selected from precursors for addition-polymerisation resins, epoxide resins, cyanate ester resins, isocyanate resins (polyurethanes) or formaldehyde condensate resins or mixtures thereof.

41. A structure comprising fine particles and an organically-modified layered inorganic species and, optionally, an organic polymeric component which, when present, comprises less than 50 wt % of the combined total weight of the particles and the species.

42. A structure according to claim 41 wherein the fine particles are selected from metal and metal oxide particles, carbon particles, conductive polymeric particles; functional and non-functional fillers and additives, colourants, pigments, curing agents, catalysts and encapsulant systems.

43. A structure according to claim 41 wherein the fine particles are selected from electrically-conductive particles.

44. A structure according to claim 41 wherein the fine particles are selected from metal and metal oxide particles and/or carbon particles.

45. A structure according to claim 41 wherein the fine particles are carbon particles.

46. A structure according to claim 41 wherein the fine particles are carbon nanotubes or carbon black.

47. A structure comprising fine particles which are high aspect ratio particles and an organically-modified layered inorganic species and, optionally, an organic polymeric component which, when present, comprises less than 50 wt % of the combined total weight of the particles and the species, wherein the fine particles are at least partially oriented.

48. A structure according to claim 47 wherein the fine particles are selected from metal and metal oxide particles, carbon particles and conductive polymeric particles.

49. A structure according to claim 47 wherein the fine particles are selected from electrically-conductive particles.

50. A structure according to claim 47 wherein the fine particles are selected from metal and metal oxide particles and/or carbon particles.

51. A structure according to claim 47 wherein the fine particles are carbon particles.

52. A structure according to claim 47 wherein the fine particles are carbon nanotubes.

53. A structure according to claim 41 consisting essentially of said fine particles and said species.

54. A structure according to claim 41 wherein the polymeric species comprises less than 35 wt % of the structure and more especially less than 25 wt % of the structure.

55. A structure according to claim 41 wherein the polymeric species comprises at least 1 wt % of the structure, more preferably at least 5 wt % of the structure and especially at least 10 wt % of the structure.

56. A structure according to claim 41 wherein the organically-modified layered inorganic species comprises an organoclay or an organically-modified layered double hydroxide.

57. A structure according to claim 41 wherein the organically-modified layered inorganic species is a natural or synthetic organoclay.

58. A structure according to claim 57 wherein the organoclay is selected from vermiculites and smectites and especially is a montmorillonite.

59. A structure according to claim 57 wherein the organoclay is an organically-modified clay wherein the interlayer metal cations have been exchanged by protonated organoammonium or organophosphonium cations, especially by organoammonium cations.

60. A structure according to claim 59 wherein the organoammonium are selected from mixtures of alkyl, hydroxyalkyl, alkenyl and aryl groups.

61. A structure according to claim 41 wherein the organically-modified layered inorganic species comprises a synthetic and naturally occurring layered double hydroxide in which organic anions have been substituted for inorganic anions within the interlayer regions thereof.

62. A structure according to claim 61 wherein the organically-modified layered inorganic species comprises a synthetic and naturally occurring layered double hydroxide of formula:
[M²⁺₁₋ₓM³⁺ₓ(OH)₂]^{y+}A^{m-}_{y/m}nH₂O
where M²⁺ is a divalent cation such as Mg²⁺, M³⁺ is a trivalent cation such as Al³⁺ and A^{m-} is the interlayer anion, the value of x being in the range 0.2 to 0.33.

63. A structure according to claim 41 wherein the polymeric component is selected from thermosetting polymers, thermoplastic polymers, elastomers and mixtures thereof.

64. A structure according to claim 41 wherein the polymer is derived from precursors for addition-polymerisation resins, epoxide resins, cyanate ester resins, isocyanate resins (polyurethanes) or formaldehyde condensate resins or mixtures thereof.

65. A structure according to claim 41 wherein the weight ratio of fine particles to organically-modified layered inorganic species is in the range 99:1 to 1:99.

66. A structure according to claim 65 wherein the weight ratio of fine particles to organically-modified layered inorganic species is not more than 90:10 and more especially is not more than 80:20.

67. A structure according to claim 65 wherein the weight ratio of fine particles to organically-modified layered inorganic species is not less than 10:90, and more especially is not less than 20:80.

68. A structure according to claim 41 comprising a film.

69. A structure according to claim 41 having a conductivity of at least 1 S cm⁻¹.

70. A structure according to claim 41 having a conductivity of at least 10 S cm⁻¹.

71. A structure according to claim 41 having a conductivity of at least 50 S cm⁻¹.

72. A structure comprising electrically-conductive fine particles and an organically-modified layered inorganic species and an organic polymeric component which comprises at least 50 wt % of the total weight of the structure, wherein said structure has an electrical percolation threshold lower than and/or a transparency greater than an equivalent structure in which the organically-modified layered inorganic species is absent.

73. A structure according to claim 72 comprising not less than 80 wt % polymeric component, more preferably not less than 85 wt % polymeric component and more especially not less than 90 wt % polymeric component.

74. A structure according to claim 72 comprising not less than 95 wt % polymeric component.

75. A structure according to claim 72 wherein the fine particles are selected from metal and metal oxide particles, carbon particles and conductive polymeric particles.

76. A structure according to claim 72 wherein the fine particles are selected from metal and metal oxide particles and/or carbon particles.

77. A structure according to claim 72 wherein the fine particles are carbon particles.

78. A structure according to claim 72 wherein the fine particles are carbon nanotubes or carbon black.

79. A structure according to claim 78 wherein the fine particles are carbon nanotubes.

80. A structure according to claim 72 wherein the organically-modified layered inorganic species comprises an organoclay or an organically-modified layered double hydroxide.

81. A structure according to claim 72 wherein the organically-modified layered inorganic species is a natural or synthetic organoclay.

82. A structure according to claim 81 wherein the organoclay is selected from vermiculites and smectites and especially is a montmorillonite.

83. A structure according to claim 81 wherein the organoclay is an organically-modified clay wherein the interlayer metal cations have been exchanged by protonated organoammonium or organophosphonium cations, especially by organoammonium cations.

84. A structure according to claim 84 wherein the organoammonium are selected from mixtures of alkyl, hydroxyalkyl, alkenyl and aryl groups.

85. A structure according to claim 72 wherein the organically-modified layered inorganic species comprises a synthetic and naturally occurring layered double hydroxide in which organic anions have been substituted for inorganic anions within the interlayer regions thereof.

86. A structure according to claim 85 wherein the organically-modified layered inorganic species comprises a synthetic and naturally occurring layered double hydroxide of formula:
[M²⁺₁₋ₓM³⁺ₓ(OH)₂]^{y+}A^{m-}_{y/m}nH₂O
where M²⁺ is a divalent cation such as Mg²⁺, M³⁺ is a trivalent cation such as Al³⁺ and A^{m-} is the interlayer anion, the value of x being in the range 0.2 to 0.33.

87. A structure according to claim 72 wherein the polymeric component is selected from thermosetting polymers, thermoplastic polymers, elastomers and mixtures thereof.

88. A structure according to claim 72 wherein the polymer is derived from precursors for addition-polymerisation resins, epoxide resins, cyanate ester resins, isocyanate resins (polyurethanes) or formaldehyde condensate resins or mixtures thereof.

89. A structure according to claim 72 wherein the polymer is derived from precursors for epoxide resins.

90. A structure according to claim 72 wherein the weight ratio of fine particles to organically-modified layered inorganic species is in the range 99:1 to 1:1.

91. A structure according to claim 90 wherein the weight ratio of fine particles to organically-modified layered inorganic species is not more than 90:10 and more especially is not more than 80:20.

92. A structure according to claim 90 wherein the weight ratio of fine particles to organically-modified layered inorganic species is not less than 3:1, and more especially is not less than 5:1.

93. A structure according to claim 72 comprising a film.
